(19) United States
(12) Patent Application Publication
(10) Pub. No.: US 2025/0166206 A1
(43) Pub. Date: May 22, 2025

(54) ELECTRONIC DEVICE OR METHOD OF OPERATION THEREOF FOR PROVIDING VIDEO EDITING FUNCTIONALITY

(71) Applicant: CODEVISION INC., Seoul (KR)

(72) Inventor: Eung Yeol SONG, Seoul (KR)

(73) Assignee: CODEVISION INC., Seoul (KR)

(21) Appl. No.: 19/031,469

(22) Filed: Jan. 18, 2025

Related U.S. Application Data
(63) Continuation of application No. PCT/KR2024/011015, filed on Jul. 29, 2024.

(30) Foreign Application Priority Data
Oct. 6, 2023 (KR) 10-2023-0133796
Oct. 10, 2023 (KR) 10-2023-0134547

(51) Int. Cl. G06T 7/12; G06T 7/194; G06T 7/20; G06V 10/25; G06V 10/46

(52) U.S. Cl. CPC G06T 7/12; G06T 7/194; G06T 7/20; G06V 10/25; G06V 10/46; G06T 2207/20044; G06V 2201/07

(57) ABSTRACT

According to various embodiments, the at least one processor may be configured to obtain a first video including a plurality of first image frames from a user device connected to the electronic device via the communication device, obtain a set of points and a set of bounding boxes for at least one object included in the first video using the object recognition model, identify the contour of the at least one object based on the set of points and the set of bounding boxes, obtain a mask for segmenting the at least one object based on the identified contour of the at least one object from the first video, obtain a second video in which regions other than the at least one object are removed from the first video using the mask.

### CROSS-REFERENCE TO RELATED APPLICATIONS

This application is a Continuation Application of International Application No. PCT/KR2024/011015, filed on Jul. 29, 2024, which is based on and claims priority to Korean Patent Application No. 10-2023-0133796, filed on Oct. 6, 2023, and Korean Patent Application No. 10-2023-0134547, filed on Oct. 10, 2023, in the Korean Intellectual Property Office, the disclosures of which are incorporated by reference herein in their entireties.

### BACKGROUND

### 1. Field

Various embodiments disclosed in this document relate to an electronic device providing a video editing function or a method of operating the same.

### 2. Description of Related Art

Recently, vision systems that provide the functionality of identifying specific objects included within a video using artificial intelligence models have been developed and are being utilized in various fields. For example, objects can be identified within a video comprising multiple image frames, and various services related to the identified objects can be provided.

Meanwhile, with respect to artificial intelligence models for identifying objects within an image, deep learning-based semantic segmentation may be considered. Numerous methods utilizing Convolutional Neural Networks (CNNs) have been extensively studied for deep learning-based semantic segmentation. A convolutional neural network is a type of multilayer feed-forward artificial neural network used for analyzing visual videos. CNNs are deep neural network techniques applied to artificial neural networks for effectively processing images. They classify images through a process in which each element of a filter represented as a matrix is automatically learned to suit data processing.

### SUMMARY

In the identification of an object in an video and the image processing related to the identified object, a representative method using a convolution neural network includes Fully Convolutional Networks (FCN). At this time, the FCN is the first proposed among the semantic segmentation methods, and uses a network for classification in segmentation. However, in the FCN, the contour of the object or the fine information is lost during the generating of the segmentation map, so that the appearance of the object is incorrectly divided.

In addition, according to various embodiments of the present disclosure, it is possible to identify the contour of the at least one included object with high accuracy and provide a high-quality video edited for the at least one object.

According to various embodiments of the present disclosure, it is possible to detect and track at least one object included in a video and identify the contour of the at least one object with higher accuracy.

Furthermore, according to various embodiments of the present disclosure, by accurately identifying the contour of the at least one included object, it is possible to provide a high-quality video edited for the at least one object.

According to various embodiments, the electronic device may include a communication device, a storage device storing an object recognition model trained to generate points and bounding boxes for at least one object included in a video, and at least one processor. The at least one processor may be configured to obtain a first video including a plurality of first image frames from a user device connected to the electronic device via the communication device, obtain a set of points and a set of bounding boxes for at least one object included in the first video using the object recognition model, identify the contour of the at least one object based on the set of points and the set of bounding boxes, obtain a mask for segmenting the at least one object based on the identified contour of the at least one object from the first video, obtain a second video in which regions other than the at least one object are removed from the first video using the mask, and transmit the second video to the user device via the communication device, such that the user device outputs the second video.

According to various embodiments, an operating method of an electronic device may include obtaining a first video including a plurality of first image frames from a user device connected to the electronic device, obtaining a first set of points and a first set of bounding boxes for at least one object included in the first video using an object recognition model trained to generate a point and a bounding box for the at least one object included in the video, identifying the at least one object based on the first set of points and the first set of bounding boxes, obtaining mask for segmenting the at least one object of the first video identified from the first video, obtaining a second video from which region excluding the at least one object of the first video is removed using the mask, and transmitting the second video such that the user device outputs the second video.

According to various embodiments, a non-volatile recording medium readable by a computer, in which a program of an operating method executable by a processor of an electronic device is recorded, the operating method may include obtaining a first video including a plurality of first image frames from a user device connected to the electronic device, obtaining a first set of points and a first set of bounding boxes for at least one object included in the first video using an object recognition model trained to generate a point and a bounding box for the at least one object included in the video, identifying the at least one object based on the first set of points and the first set of bounding boxes, obtaining mask for segmenting the at least one object of the first video identified from the first video, obtaining a second video from which region excluding the at least one object of the first video is removed using the mask, and transmitting the second video such that the user device outputs the second video.

According to various embodiments, the electronic device may include at least one camera, a display device, a communication device, a storage device storing an object recognition model trained to generate a point and a bounding box for the at least one object included in the video, and at least one processor, and the at least one processor may be configured to obtain the first video including a plurality of first image frames through the at least one camera, obtain a point set and a bounding box set for the at least one object included in the first video using the object recognition model, identify contour of the at least one object based on the point set and the bounding box set, obtain mask for segmenting the at least one object based on the contour of the at least one object identified from the first video, obtain a second video from which the region excluding the at least one object of the first video is removed using the mask, and control the display device such that the display device outputs the second video.

Various embodiments of the present disclosure may detect and track at least one object included in video obtained from a user device to identify the contour of the at least one object. In this case, the electronic device according to various embodiments may identify the contour of the at least one object with higher accuracy by utilizing both a bounding box generation and a key-point generation for the at least one object.

Further, various embodiments of the present disclosure may identify at least one object included a in video obtained from a user device to generate video edited for the at least one object. For example, the video may be generated by recognizing at least one object included in the video to remove the remainder except for the at least one object or an image edited in relation to the at least one object.

Through the electronic device according to various embodiments of the disclosure, the user may obtain video edited with higher accuracy for the at least one object included in the video. Accordingly, the user may obtain the edited image as intended.

The electronic device according to various embodiments of the disclosure may provide various functions related to video editing to provide increased user convenience for image editing.

The electronic device according to various embodiments of the present disclosure uses the residual U-block technology, since it is possible to use a low-dimensional video and a high-dimensional video in a decoder, even if the object recognition model performs learning with a small number of learning data, it may exhibit accurate object identification performance.

In addition, various effects directly or indirectly understood through the present document may be provided.

### BRIEF DESCRIPTION OF THE DRAWINGS

FIG. 1 is a diagram illustrating a system that provides a video editing function according to various embodiments.

FIG. 2 is a block diagram of an electronic device according to various embodiments.

FIG. 3 shows a concept of controlling a function related to editing of a video in an electronic device according to various embodiments.

FIG. 4 is a flowchart illustrating an operation of generating video from which region except for at least one object is removed by an electronic device according to various embodiments.

FIG. 5 is a flowchart illustrating an operation in which an electronic device obtains a contour of at least one object by grouping a plurality of image frames within video obtained from a user device according to various embodiments.

FIG. 6 is a diagram for describing mask generated by an electronic device according to various embodiments.

FIG. 7 is a diagram for describing video from which a background is removed based on mask generated by an electronic device according to various embodiments.

FIG. 8 is a flowchart illustrating an operation in which an electronic device obtains a user input with respect to a contour of at least one object generated using an object recognition model according to various embodiments.

FIG. 9 is a flowchart illustrating an operation of generating an video edited with respect to at least one object based on a user input by an electronic device according to various embodiments.

FIG. 10 is a diagram for describing video edited through mask generated by an electronic device based on a user input according to various embodiments.

FIG. 11 is a diagram for describing video edited through mask generated by an electronic device based on a user input according to various embodiments.

FIG. 12 shows an execution screen output through a user device according to various embodiments.

FIG. 13A illustrates an execution screen of a user input for a bounding box output through a user device according to various embodiments.

FIG. 13B shows an execution screen of a user input for a bounding box output through a user device according to various embodiments.

FIG. 13C shows an execution screen output through a user device as a user input for a bounding box is obtained according to various embodiments.

FIG. 14 is a diagram for explaining that an electronic device applies a user input according to various embodiments.

FIG. 15 is a diagram illustrating that the electronic device generates mask when the user input for the bounding box is the object addition input according to various embodiments.

FIG. 16A illustrates an execution screen of a user input for a key-point output through a user device according to various embodiments.

FIG. 16B illustrates an execution screen of a user input for a key-point output through a user device according to various embodiments.

FIG. 16C illustrates an execution screen output through a user device as a user input for a key-point is obtained according to various embodiments.

FIG. 17 is a diagram for explaining that an electronic device applies a user input according to various embodiments.

FIG. 18 illustrates an execution screen of a user input for mask output through a user device according to various embodiments.

FIG. 19A illustrates an execution screen of a user input for selecting at least one object from among a plurality of objects in an video frame according to various embodiments.

FIG. 19B illustrates an execution screen of a text-based user input for selecting at least one object from among a plurality of objects in an video frame according to various embodiments.

FIG. 19C illustrates an execution screen of a text-based user input for selecting at least one object from among a plurality of objects in an video frame according to various embodiments.

In relation to the description of the drawings, the same or similar reference numerals may be used for the same or similar components.

### DETAILED DESCRIPTION

Specific structural or functional descriptions of various embodiments are merely illustrated for the purpose of describing the various embodiments, and they should not be construed as being limited to the embodiments described in this specification or the application.

Various embodiments can be variously modified and have various forms, and thus various embodiments are illustrated in the drawings and will be described in detail in this specification or the application. However, it should be understood that the matter disclosed from the drawings is not intended to specify or limit various embodiments, but includes all modifications, equivalents, and alternatives included in the spirit and scope of the various embodiments.

The terms first and/or second, etc., may be used to describe various components, but the components should not be limited by the terms. The terms are only for the purpose of distinguishing one component from another component, for example, the first component may be named a second component, and similarly, the second component may be named a first component, without deviating from the scope of rights according to the concept of the present disclosure.

When an element is referred to as being “connected” or “connected” to another component, it should be understood that the element may be directly connected or connected to the other component, but other components may be present in the middle. On the other hand, when an element is referred to as being “directly connected” or “directly connected” to another component, it should be understood that there is no intervening component. Other expressions that describe the relationship between components, that is, “between” and “immediately between” or “adjacent to” and “directly adjacent to” should be interpreted as well.

The terminology used in this specification is used merely to describe a specific embodiment, and is not intended to limit various embodiments. The singular expression includes plural expressions unless the context clearly dictates otherwise. In this specification, it should be understood that the terms “include” or “have” are intended to designate the presence of stated features, numbers, steps, operations, components, parts or combinations thereof, but do not preclude the presence or addition of one or more other features, numbers, steps, operations, components, parts or combinations thereof.

Unless defined otherwise, all terms used herein, including technical or scientific terms, are the same meaning as commonly understood by one of ordinary skill in the art to which this disclosure belongs. Terms such as those defined in commonly used dictionaries should be interpreted to have a meaning that is consistent with the contextual meaning in the relevant art, and is not interpreted in an ideal ready or overly formal sense unless clearly defined in this specification.

Hereinafter, the present disclosure will be described in detail with reference to the preferred embodiments of the present disclosure with reference to the accompanying drawings. The same reference numerals provided in each drawing indicate the same members.

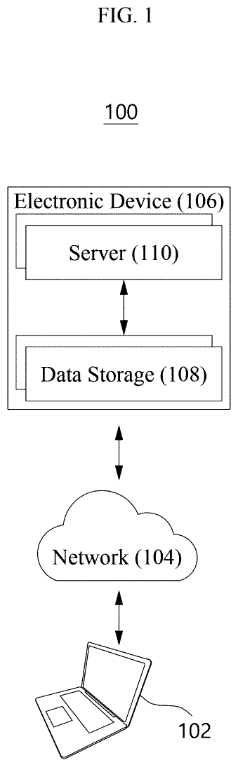

FIG. 1 is a diagram illustrating a video editing system that provides a video editing function according to various embodiments.

Referring to FIG. 1, the video editing system 100 may include a user device 102, a network 104, and an electronic device 106.

Meanwhile, the video of this document may be expressed as an video. In addition, points for at least one object in the video may be mixedly used as key-point expression.

According to various embodiments, the user device 102 is a device including a marker device, and may be a mobile phone, a smart phone, a personal digital assistant (PDA), a notebook computer, a television (TV), a wearable device, or a head mounted device (HMD).

According to various embodiments, the user device 102 may include various output devices that may provide video content to the user. For example, the user device 102 may include at least one of an audio device, a display device, or at least one camera that may obtain video.

According to various embodiments, the user device 102 may include various input devices that may obtain input from the user. For example, the user device 102 may include at least one of a keyboard, a touch pad, a key (e.g., button), a mouse, a microphone, or a digital pen (e.g., a stylus pen).

According to various embodiments, the network 104 may include any variety of wireless communication networks suitable for coupling to communicate with the user device 102. For example, the network 104 may include WLAN, WAN, PAN, cellular, WMN, WiMAX, GAN, and 6LowPAN.

According to various embodiments, the electronic device 106 may include a standalone host computing system, an on-board computer system integrated with the user device 102, a mobile device, or any other hardware platform that may provide a video editing function and video content to the user device 102. For example, the electronic device 106 may include a cloud-based computing architecture suitable for servicing video editing executed in the user device 102. Accordingly, the electronic device 106 may include one or more servers 110 and a data storage 108. For example, the electronic device 106 may include a software as service (SaaS), a platform as service (PaaS), an infrastructure as service (IaaaS), or another similar cloud-based computing architecture.

According to various embodiments, the electronic device 106 and/or the user device 102 may be configured as one device that performs each function without being limited to the illustrated example.

For example, the electronic device 106 may perform the function of the user device 102, including the configuration included in the user device 102. When the electronic device 106 provides the function of the user device 102, the electronic device 106 may provide the editing function of the video stored in the electronic device 106. For example, the electronic device 106 may obtain and store the video including a plurality of image frames, audio information, and/or subtitle information through camera and microphone. In addition, the electronic device 106 may edit video based on the user input and output the edited video through the display device.

It will be described later that the electronic device 106 provides the editing function of the video.

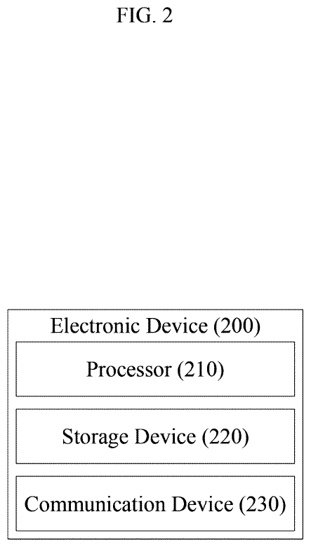

FIG. 2 is a block diagram of an electronic device 200 according to an embodiment. Referring to FIG. 2, the electronic device 200 (e.g., the electronic device 106 of FIG. 1) may include a processor 210, a storage device 220 (e.g., the data storage 108 of FIG. 1), and/or a communication device 230. The above enumerated components may be operatively or electrically connected to each other. As an example, some of the components of the electronic device 200 illustrated in FIG. 2 may be modified, deleted, or added.

According to various embodiments, the electronic device 200 may include a processor 210. The processor 210 may include hardware for executing a command, such as a command constituting a computer program. For example, the processor 210 may retrieve (or patch) the command from the internal register, the internal cache, the storage device 220 (including the memory), decode and execute the command, and store the result in the internal register, the internal cache, and the storage device 220.

In various embodiments, the processor 210 may execute software (e.g., a computer program) to control at least one other component (e.g., a hardware or software component) of the electronic device 200 connected to the processor 210, and may perform various data processing or calculations. According to various embodiments, as at least a part of the data processing or calculation, the processor 210 may store the command or data received from the other component (e.g., the communication device 230) in volatile memory, process the command or data stored in the volatile memory, and store the result data in non-volatile memory.

According to various embodiments, the processor 210 may include at least one of a central processing unit (CPU), a graphics processing unit (GPU), a micro controller unit (MCU), a sensor hub, an auxiliary processor, a communication processor, an application processor, an application specific integrated circuit (ASIC), a field programmable gate array (FPGA), or a neural processing unit (NPU), and may have a plurality of cores.

According to various embodiments, the processor 210 (e.g., the neural network processing device) may include a hardware structure specialized for processing the artificial intelligence model. The artificial intelligence model may be generated through machine learning. The learning algorithm may include, for example, supervised learning, unsupervised learning, semi-supervised learning, or reinforcement learning, but is not limited to the above example. The artificial intelligence model may include a plurality of artificial neural network layers. The artificial neural network may be one of deep neural network (DNN), convolutional neural network (CNN), recurrent neural network (RNN), restricted Boltzmann machine (RBM), deep belief network (DBN), bidirectional recurrent deep neural network (BRDNN), deep Q-networks, or a combination of two or more of the above, but is not limited to the above example. The artificial intelligence model may additionally or alternatively include a software structure in addition to the hardware structure.

According to various embodiments, the processor 210 may obtain a first image including a plurality of image frames from the user device (e.g., the user device 102 of FIG. 1). For example, the first video may include a plurality of video frames having a series of temporal flow and audio information and/or subtitle information corresponding to the plurality of video frames.

According to various embodiments, the first video may include an image captured through at least one camera of the user device 102. For example, a user may photograph an video using the user device 102 and transmit the video to the electronic device 200 to edit the image.

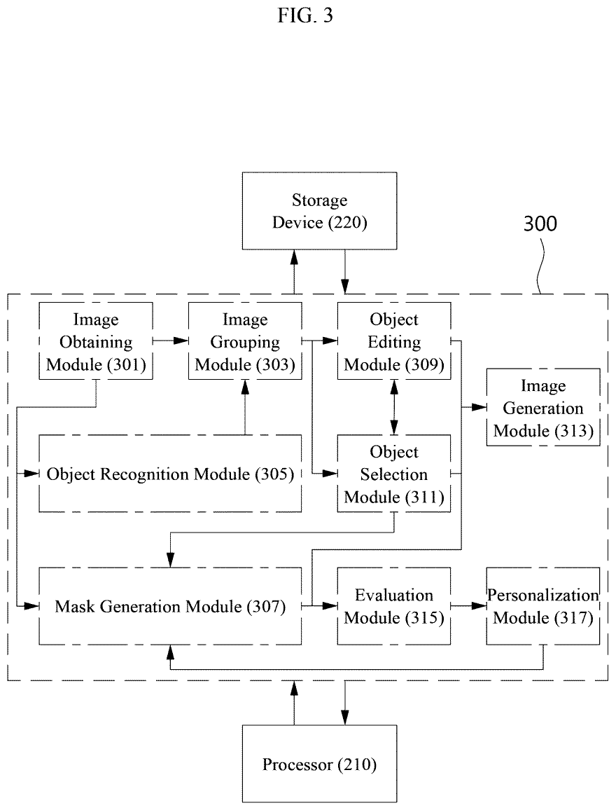

According to various embodiments, the processor 210 may obtain a first point set and a first bounding box set for at least one object included in the first video using an object recognition model (e.g., the object recognition model of the object recognition module 305 described with reference to FIG. 3) trained to generate a point and/or bounding box for at least one object included in the video. For example, the processor 210 may input the first video to the object recognition model. In addition, it is possible to obtain a first point set and a first bounding box set of at least one object generated by recognizing at least one object for each of the plurality of video frames of the first video output from the object recognition model.

According to various embodiments, the processor 210 may recognize the first contour for the at least one object based on the first point set and the first bounding box set. For example, the processor 210 may identify the first contour of the at least one object by applying all of the first set of bounding boxes including the at least one bounding box of the at least one object and the first set of points extracting the skeleton data for the at least one object included in the first video.

The electronic device 200 according to various embodiments may identify the first contour for the at least one object with a higher accuracy by using both the generation of a bounding box set and the generation of a key-point set for the at least one object.

According to various embodiments, the processor 210 may obtain mask for segmenting the at least one object based on the first contour of the at least one object identified from the first video. For example, the processor 210 may obtain mask for segmenting the at least one object for each of a plurality of image frames of the first video. According to various embodiments, the mask may include an video for covering, modifying, or editing a specific portion of an video frame.

According to various embodiments, the processor 210 may obtain a second video from which a region excluding at least one object of the first video is removed using the mask. For example, the processor 210 may obtain a second video in which the region excluding the at least one object is removed for each of the plurality of image frames of the first video by using mask for each of the plurality of image frames of the first video.

According to various embodiments, the processor 210 may obtain the second video by encoding the image frames from which the area except for the at least one object is removed for each of the plurality of image frames of the first video and the audio information and/or caption information of the first video using the mask.

According to various embodiments, when the at least one object is a foreground of the first video, the second video may include

[symbol]

According to various embodiments, the processor 210 may transmit the second video so that the user device 102 outputs the second video. For example, the processor 210 may transmit the second video to the user device 102 through the communication device 230.

According to various embodiments, the user device 102 that obtains the second video may output the second video through a display device (e.g., a display) included in the user device 102.

According to various embodiments, the processor 210 may generate mask based on a user input obtained through the user device 102.

According to various embodiments, the processor 210 may transmit to the user device 102 to display the first point set and/or the first bounding box set. For example, the processor 210 may transmit information on the first point set and/or the first bounding box set to the user device 102 through the communication device 230.

According to various embodiments, the user device 102 obtaining the second video may output information on the first point set and the first bounding box set through a display device (e.g., a display) included in the user device 102 using a visual object. For example, the user device 102 may overlap and display visual objects for each of the first point set and the first bounding box set for each of the plurality of video frames included in the first video.

According to various embodiments, the processor 210 may obtain a first user input for the at least one object included in a first image frame among a plurality of image frames for the first video through the user device 102. For example, the processor 210 may obtain a user input for a point set and/or a bounding box set of the first video frame displayed through the user device 102.

According to various embodiments, the user input may include various inputs for the at least one object of the first video frame. For example, it may include at least one of an input for selecting the at least one object, an input for a point set of the at least one object, an input for a bounding box of the at least one object, masking input for a point set of the at least one object, and a text input related to selecting a contour of the at least one object.

According to various embodiments, the processor 210 may identify a second contour of at least one object of the first video frame based on the user input. For example, the processor 210 may identify the contour of at least one object of the first video frame among the plurality of video frames of the first video as the second contour based on the user input.

According to various embodiments, the processor 210 may obtain mask for segmenting the at least one object for the first video based on the first contour and/or the second contour. For example, a mask may be obtained based on a second contour of at least one object of the first image frame and a first contour of at least one object of the remaining image frames among a plurality of image frames included in the first video.

According to various embodiments, the processor 210 may obtain a second video edited for the at least one object by using a mask obtained based on the first contour and/or the second contour to edit the first video for each of the plurality of image frames in the first video.

According to various embodiments, the second video may be obtained by encoding image frames edited for the at least one object using a mask obtained based on the first contour and the second contour, audio information of the first video, and/or subtitle information of the first video.

According to various embodiments, the processor 210 may transfer the second image so that the user device 102 outputs the second video. For example, the processor 210 may transfer the second video to the user device 102 through the communication device 230.

According to various embodiments, the user device 102 that obtained the second video may output the second image through a display device (e.g., a display) included in the user device 102.

According to various embodiments, the storage device 220 may include a large storage for data or commands. For example, the storage device 220 may include a hard disk drive (HDD), a floppy disk drive, a flash memory, an optical disk, a magneto-optical disk, a magnetic tape, or a universal serial bus (USB) drive, or a combination of two or more thereof.

In various embodiments, the storage device 220 may include a non-volatile, solid-state memory, and read-only memory (ROM). Such ROM may be programmed ROM, a programmable ROM (PROM), an erasable PROM (EPROM), an electrically erasable PROM (EEPROM), an electrically changeable ROM (EAROM), or a flash memory, or a combination of two or more thereof.

Although the present disclosure describes and illustrates a specific storage device, the present disclosure contemplates any suitable storage device, and according to various embodiments, the storage device 220 may be inside or outside of the electronic device 106.

According to various embodiments, the processor 210 may store a module related to editing a video described with reference to FIG. 3 in the storage device 220.

According to various embodiments, the processor 210 may execute calculations or data processing related to control and/or communication of at least one other component of the electronic device 200 using instructions stored in the storage device 220.

According to various embodiments, the electronic device 200 may include the storage device 220. According to various embodiments, the storage device 220 may store various data used by at least one component (e.g., the processor 210) of the electronic device 200. The data may include, for example, software (e.g., a program) and input data or output data for a command related thereto.

According to various embodiments, the program may be stored as software in the storage device 220, and may include, for example, an operating system, middleware, or an application. According to various embodiments, the storage device 220 may store instructions that process data or control components of the electronic device 200 to perform an operation of the electronic device 200 when the processor 210 is executed. The instructions may include code generated by a compiler or code that can be executed by an interpreter.

According to various embodiments, the storage device 220 may store various information obtained through the processor 210. For example, the storage device 220 may store at least one of a plurality of video frames obtained from the processor 210, an video including a plurality of video frames, order information of each of the plurality of video frames, information on video frames groups grouped by grouping the plurality of video frames, information on at least one object of each of the plurality of video frames, information on a point set group and a bounding box set for the at least one object output through an object recognition model, and user input information obtained from the user device 102. In addition, the storage device 220 may store identification information for the user device 102 connected to the electronic device 200.

According to various embodiments, the storage device 220 may extract skeleton data for at least one object of to obtain a point set, and store an object recognition model trained to obtain a bounding box set for the at least one object. For example, the object recognition model may be a deep neural network model trained to identify and track an object in video to extract a key-point set and a bounding box set for at least one object in the image.

According to various embodiments, the electronic device 200 may include a communication device 230. In various embodiments, the communication device 230 may support the establishment of a direct (e.g., wired) communication channel or a wireless communication channel between the electronic device 200 and an external electronic device (e.g., the user device 102 of FIG. 1), and communication performance through the established communication channel. The communication device 230 may include one or more communication processors that operate independently from the processor 210 and support direct (e.g., wired) communication or wireless communication. According to an embodiment, the communication device 230 may include a wireless communication module (e.g., a cellular communication module, a short-range wireless communication module, or a global navigation satellite system (GNSS) communication module) or a wired communication module (e.g., a local area network (LAN) communication module or a power line communication module). A corresponding communication module among these communication modules may communicate with an external electronic device through a first network (e.g., the network 104 of FIG. 1) (e.g., a short-range communication network such as Bluetooth, wireless fidelity direct (WiFi direct), or infrared data association (IrDA)) or a second network (e.g., the network 104 of FIG. 1) (e.g., a legacy cellular network, a 5G network, a next-generation communication network, the Internet, or a computer network (e.g., the network 104 of FIG. 1) (e.g., a long-range communication network such as LAN or WAN). The various types of communication modules may be integrated into one component (e.g., a single chip) or may be implemented into a plurality of separate components (e.g., a plurality of chips).

According to various embodiments, the electronic device 200 may transmit and receive various data to and from various external devices through the communication device 230. In addition, the electronic device 200 may store the obtained data in the storage device 220. For example, the electronic device 200 may obtain an video including a plurality of video frames from the user device 102 through the communication device 230. For example, the electronic device 200 may obtain user input for at least one object included in the video through the communication device 230. For example, the electronic device 200 may deliver information on a point set and a a bounding box set for at least one object of the video to the user device 102 through the communication device 230. For example, the electronic device 200 may transfer the video edited by the image with respect to the at least one object to the user device 102 through the communication device 230.

According to various embodiments, the electronic device 200 may include a computer system. For example, the computer system may be at least one of a buried computer system, a system-on-chip (SOC), a single-board computer system (SBC), a computer-on-module (COM), a desktop computer system, a laptop or notebook computer system, a server, a tablet computer system, and a mobile terminal. For example, the electronic device 200 may include one or more computer systems resident in a cloud that may include one or more cloud components.

According to various embodiments, the electronic device 200 may perform one or more operations of one or more methods described or shown in this disclosure without substantial spatial or temporal limitation. In addition, the electronic device 200 may perform one or more operations of one or more methods described or shown in this disclosure in real time or in a batch mode. For example, the electronic device 200 may perform one or more operations of one or more methods described or shown in this disclosure at different times or at different positions.

According to various embodiments, a non-transitory readable recording medium may be provided that stores computer instructions to perform the operations of the electronic device 200 described in this disclosure. The non-transitory readable recording medium or storage medium may include one or more semiconductor-based or other integrated circuits (ICs) (such as field-programmable gate arrays (FPGAs) or application-specific ICs (ASICs), hard disk drives (HDDs), hybrid hard drives (HHDs), optical disks, optical disk drives (ODDs), magneto-optical disks, magneto-optical drives, floppy disks, floppy disk drives (FDD), magnetic tapes, solid-state drives (SSDs), RAM-drives, SECURE DIGITAL cards or drives, any other suitable computer-readable non-transitory storage medium, or any suitable combination of two or more thereof, as appropriate.

According to various embodiments, the computer-readable non-transitory recording medium may be volatile, non-volatile, or a combination of volatile and non-volatile, as appropriate. The recording medium that can be read by the device may be provided in the form of a non-transitory recording medium. Here, the term “non-transitory recording medium” means that it is a tangible device and does not include a signal (e.g., electromagnetic wave), and this term does not distinguish between a case where data is semi-permanently stored in the recording medium and a case where data is temporarily stored. For example, the “non-transitory recording medium” may include a buffer that temporarily stores data.

The method of operating the electronic device according to variousous embodiments disclosed herein may be included in a computer program product may be provided in a computer program product. The computer program product may be traded between s s s s s s of sales and buys. The computer program product may be distributed in the form of a device readable recording medium (e.g., compact disc read only memory (CDROM)), or distributed may be directly distributed (e.g., downloaded or uploaded) online between two user devices (e.g., smartphone) or through an application store (e.g., a play store™)). In the case of online distribution, at least a portion of a computer program product (e.g., a downloadable app) may be at least temporarily stored in a storage medium readable by a device such as a server of a manufacturer, a server of an application store, or a memory of a relay server.

According to various embodiments, when the electronic device 200 described in this disclosure provides the function of the user device 102, the electronic device 200 may include at least one camera (not shown) and/or a display device (not shown). Hereinafter, a case in which the electronic device 200 includes at least one camera (not shown) and/or a display device (not shown) will be described.

According to various embodiments, the processor 210 may obtain the first video including a plurality of image frames through at least one camera. For example, the processor 210 may activate the at least one camera based on a start photographing command, and obtain the first image including a plurality of image frames, audio information, and/or caption information through the at least one camera.

According to various embodiments, the processor 210 may identify the contour of at least one object included in the first video using an object recognition model, and obtain mask for segmenting the at least one object based on a first contour of the at least one object. This will be abbreviated because it is duplicated with the above description.

According to various embodiments, the processor 210 may obtain a second video from which the region excluding the at least one object of the first video is removed using the mask, and control the display device to output the second video. For example, the processor 210 may output the second video through the display device included in the electronic device 200.

According to various embodiments, when the processor 210 generates the mask based on a user input, the processor 210 may control the display device to display the first point set and the first bounding box set for the at least one object. For example, the display device may overlap and display the visual object for each of the first point set and the first bounding box set for each of the plurality of video frames included in the first video through the control of the processor 210.

According to various embodiments, the processor (210) may obtain user input for the at least one object included in the first image frame among the plurality of image frames. For example, the processor 210 may obtain the user input through an input device included in the electronic device 200, such as a keyboard, touchpad, key (e.g., button), mouse, microphone, or digital pen (e.g., stylus pen).

According to various embodiments, the processor 210 may identify the second contour of the at least one object of the first video frame based on the user input. In addition, the processor 210 may obtain the mask for segmenting the at least one object based on the first contour and the second contour of the at least one object. This will be abbreviated because it is duplicated with the above description.

According to various embodiments, the processor 210 may obtain a second video obtained by editing the first video in relation to the at least one object using the mask, and control the display device to output the second.

FIG. 3 shows a concept of controlling functions related to editing videos in electronic devices according to various embodiments.

Referring to FIG. 3, the electronic device 200 may use hardware and/or software module 300 to support functions related to editing various videos. For example, the processor 210 may drive the video obtaining module 301, the video grouping module 303, the object recognition module 305, the mask generation module 307, the object editing module 309, the object selection module 311, the video generation module 313, the evaluation module 315, and/or the personalization module 317 by executing the instructions stored in the storage device 220. In various embodiments, a software module different from that shown in FIG. 3 may be implemented. For example, at least two modules may be integrated into one module or one module may be divided into two or more modules. In addition, the hardware and software modules may share one function to improve work performance. For example, the electronic device 200 may include both an encoder implemented in hardware and an encoder implemented in software modules, and some of the data obtained through at least one camera module may be processed in a hardware encoder and some of the other in a software encoder.

According to various embodiments, the video obtaining module 301 may provide a UI (User Interface)/GUI (graphical UI) related to video upload to a user through the user device 102 and obtain a video (e.g., the first video described with reference to FIG. 2) through the user device. For example, the video may be obtained by controlling a function related to video upload in response to a user input provided through ui/gui output through the display device of the user device 102. In addition, the video obtaining module 301 may extract a plurality of video frames, audio information, and/or subtitle information of the video obtained through the user device 102.

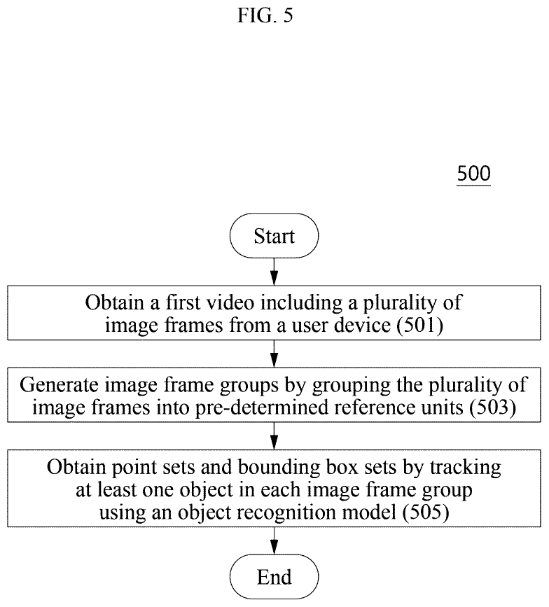

According to various embodiments, the image grouping module 303 may generate image frame groups by grouping the plurality of image frames included in the video obtained through the video obtaining module 301 by a predetermined reference unit. For example, the video grouping module 303 may recognize the scene switching of the video using the object recognition model included in the object recognition module 305 and generate video frame groups by grouping the plurality of video frames of the video based on the scene switching. An operation of the video grouping module 303 generating video frame groups based on the scene switching will be described below with reference to FIG. 5.

According to various embodiments, the object recognition module 305 may include an object recognition model trained to detect a set of points and/or a bounding box for at least one object included in a video. For example, the object recognition model may be a model trained through various training data to detect a set of points and/or a set of bounding boxes for at least one object.

According to various embodiments, the learning data for learning the object recognition model may include learning data obtained by distinguishing at least one object and background within the plurality of video frames included in the video and assigning labels corresponding to the background and labels corresponding to the at least one object, respectively.

According to various embodiments, the object recognition model may be configured as an artificial neural network model. For example, the object recognition model may be a deep neural network model trained to identify and track objects within the video and extract key-point sets and bounding box sets for at least one object within the video. For example, the object recognition model may be implemented as a region-based convolutional neural network model (Region-based Convolution Neural Network, R-CNN), a high speed region-based convolutional neural network model (Faster R-CNN), a single shot multibox detector model (Single Shot Multibox Detector, SSD), YOLO v4, CenterNet, or MobileNet. However, the object recognition model of the present disclosure is not limited to the above-described deep neural network model, but may be implemented as other suitable neural network models.

According to various embodiments, the object recognition model may extract skeleton data of at least one object included in a video to obtain a set of points. For example, the object recognition model may extract at least one object included in the video, extract the skeleton data of the extracted object, and obtain a set of points. For instance, if the object is a human or an animal, the model may detect joint areas or specific parts of the object. In the case where the object is a human, it may extract body parts such as the head, eyes, nose, mouth, ears, neck, shoulders, elbows, wrists, fingertips, torso, hips, knees, ankles, and toes. The skeleton data may be represented as XY coordinates in the video, forming a set of points.

According to various embodiments, the object recognition model may use joint detection algorithms such as Kinetics data sets or NTU-RGB-D (Nanyang Technological University's Red Blue Green and Depth information) data sets to extract skeleton data of joints or specific parts of the body to obtain a point set. In this case, the number of skeleton joints per at least one object may be arbitrarily defined.

According to various embodiments, the set of points may include Skeleton Key Points composed of XY coordinates generated based on a model structured to represent the shape of a body and Face Key Points composed of XY coordinates generated based on a model targeting the individual positions of facial features such as eyes, nose, and mouth.

According to various embodiments, the object recognition model may track at least one object in a video. For example, it may track at least one recognized object from a plurality of image frames included in the video, thereby tracking changes in the at least one object across the plurality of image frames. In cases where multiple objects are included in an image frame, the object recognition model may extract skeleton data for each of the multiple objects, obtain a set of points, generate layers for each of the multiple objects, and track them. According to various embodiments, when multiple objects included in the video are recognized at specific time intervals, layers may be generated for each time interval in which the objects are recognized.

According to various embodiments, the object recognition model of the electronic device 200 may include an encoder and a decoder for extracting a bounding box set from a plurality of video frames in the video.

According to various embodiments, the encoder and the decoder may include a plurality of stages, wherein the plurality of stages may comprise some encoder stages, some decoder stages, and a bridge stage connecting the encoder stages and the decoder stages. In one embodiment, each of the plurality of stages may include a residual U-block.

According to various embodiments, the encoder and the decoder may be connected to a network having an overlapped U-shaped structure. Such an overlapped U-shaped structure may extract multi-scale features of an intra-stage and more effectively combine them. The encoder may extract and compress the features from the video frame of the video to generate context information. The decoder may be configured to output a bounding box set based on segmentation by expanding a feature map including the context information.

According to various embodiments, the U-shaped network may include encoder stages (including a bridge stage), decoder stages, and a bridge stage. This U-shaped network minimizes information loss by utilizing intermediate feature information from the encoder in the decoder through concatenation operations. As a result, compared to conventional Fully Convolutional Networks (FCNs), segmentation accuracy (the accuracy of bounding box set extraction) can be improved.

According to various embodiments, the object recognition model may include a residual U-block. Here, the residual U-block may be an improved concept of the conventional residual block. For example, the residual block, which is used in the ResNet algorithm, may be extended in the residual U-block to include the concept of multi-scale features and local feature functions.

According to various embodiments, the residual block may include a process of adding an input value of a scale feature and a local feature point function of each layer to an output value. Due to the use of the residual U-block, the electronic device 200 may use a low-dimensional video and a high-dimensional video in the decoder. Accordingly, even if the object recognition model performs learning with a small number of learning data R, it may exhibit accurate object identification (acquisition of a point set and a bounding box set) performance.

Therefore, the object recognition model of the electronic device 200 according to an embodiment of the present disclosure can significantly reduce the number of layers in the encoder and decoder networks by utilizing the residual U-block. This reduces computational complexity and increases processing speed while enhancing the calculation of hierarchical downsampling vectors in each block, thereby enabling accurate identification of objects at various resolutions.

According to various embodiments, the object recognition module 305 may identify the at least one object with higher accuracy by utilizing both the point set and the bounding box for the at least one object of each of the plurality of video frames using the object recognition model.

In addition, the object recognition module 305 may generate the point set and the bounding box set of each of the plurality of objects when the plurality of objects exist in the input video.

According to various embodiments, the mask generation module 307 may identify a first contour of at least one object in the video based on the set of points and bounding box for the at least one object and generate a mask for segmenting the at least one object based on the identified contour (including boundaries) of the at least one object. According to various embodiments, the mask generation module (307) may generate a mask for segmenting the at least one object for each of the plurality of image frames included in the video.

The mask may include video for hiding, modifying, or editing a specific part of the video frame. Alternatively, the mask may include ‘0’ and ‘1’ map data, and may include ‘0’ or ‘1’ data for each of the plurality of pixels of the video frame.

According to various embodiments, the mask generation module 307 may generate a mask based on sequence information of each of the plurality of image frames in the video, the set of points and the set of bounding boxes, and/or user information. For example, the mask generation module 307 may obtain user input for at least one object in a specific image frame among the plurality of image frames from a user device and generate a mask using the additional user inputs. For instance, the mask generation module 307 may identify the contour of the at least one object based on the sequence information of the specific image frame and the user input, and generate a mask based on the identified contour.

For example, the mask generation module 307 may obtain a first contour based on the set of points and bounding box set determined through the object recognition module (305), and obtain a second contour based on the user input for the at least one object, thereby identifying the shape of the at least one object and generating mask(s) for the identified object(s).

According to various embodiments, the mask generation module 307 may apply the user input for at least one object in a specific image frame to other image frames beyond the specific image frame and generate masks for each of the other image frames based on the user input obtained via the user device.

According to various embodiments, the user input for the at least one object may be obtained through the object editing module 309 and/or the object selection module 311.

According to various embodiments, the object editing module 309 may provide ui/gui for a user input for the at least one object included in a specific image frame (e.g., the first image frame described with reference to FIG. 2) among the plurality of image frames of the video to the user through the user device 102, and may obtain a user input for a point set and/or a bounding box set for the at least one object through the user device. In an example, the user input may include at least one of a point set input or a bounding box set input for the at least one object. Accordingly, the object editing module 309 may identify a edition request for the at least one object based on the point set input or the bounding box set input, and may edit the at least one object included in the specific image frame based on the edition request. The object editing module 309 may provide information on the user input related to the edition request to the mask generation module 307. The contour of the at least one object edited based on the user input may be identified.

In addition, according to various embodiments, the object edition module 309 may For example, the pixels for the at least one object of the specific image frame may be edited based on the edition request for the at least one object to generate the edited specific image frame. According to various embodiments, the object editing module 309 may use various generated neural network models (e.g., generative adversarial networks (GAN)) in generating the edited specific image frame.

According to various embodiments, the object selection module 311 may provide a UI/GUI to the user for user input regarding at least one object included in a specific image frame (e.g., the first image frame described with reference to FIG. 2) among the plurality of image frames in the video and obtain user input for the at least one object via the user device. For example, the object selection module 311 may obtain user input to select at least one object to be identified among the multiple objects included in the video.

In addition, according to various embodiments, the object selection module 311 may obtain a user input including any one of input for a point set for the at least one object included in a specific frame, input for a bounding box of the at least one object, masking input for a point set of the at least one object, and text input related to selecting the contour of the at least one object, and may provide information on the user input to the mask generation module 307.

According to various embodiments, the image generation module 313 may obtain the edited video by rendering the plurality of image frames using mask corresponding to each of the plurality of image frames obtained through the mask generation module 307. For example, the edited video may be obtained by convolution the plurality of image frames of the video with the mask corresponding to each of the plurality of image frames. For example, when the mask is composed of the map data, when the mask value for the video frame is “1”, the video frame may be output in a specified color or removed. In addition, when the mask map data is “0”, the video of the corresponding pixel may be output as it is.

According to various embodiments, the video generation module 313 may obtain an edited video by encoding the video edited for at least one object in each of the plurality of image frames of the original video, along with the audio information and/or subtitle information of the original video, based on the data provided by the object editing module (309), the object selection module 311, and/or the mask generation module 307.

According to various embodiments, the evaluation module 315 may provide UI/GUI related to the feedback of the mask generated from the mask generation module 307 to the user through the user device 102, and obtain the user feedback through the user device. Accordingly, according to various embodiments, the evaluation module 315 may obtain feedback information indicating user s satisfavorable mask generated for each of the plurality of image frames, and may re-train the object recognition model included in the object recognition module 305 using the feedback information.

According to various embodiments, the personalization module 317 may control the mask generation module 307 to be customized for the user by utilizing information about masks generated by the mask generation module 307, user input information obtained through various modules, and/or feedback information obtained through the evaluation module 315. For example, feedback information representing user satisfaction with the masks generated for each of the plurality of image frames may be obtained from the evaluation module 315, and the object recognition model included in the object recognition module (305) may be retrained using the feedback information, enabling the use of a user-customized object recognition model.

Alternatively, user input information related to mask generation may be stored, allowing the mask generation module 307 to generate masks based on the stored input information (e.g., macro-based method or manipulation history information) without requiring the user to repeatedly input the information via the user device.

In the embodiment illustrated in FIG. 3, the functions performed by the video acquisition module (301), image grouping module 303, object recognition module 305, mask generation module 307, object editing module 309, object selection module 311, video generation module 313, evaluation module 315, and/or personalization module 317 may be understood as being executed by the processor (210) based on instructions stored in the storage device 220. Additionally, in various embodiments, the electronic device 200 may use one or more hardware processing circuits to perform the various functions and operations disclosed in this document.

Furthermore, the hardware/software connections depicted in FIG. 3 are provided for explanatory convenience and do not limit the flow/direction of data or commands. The components included in the electronic device 200 may have various electrical/operational interconnections.

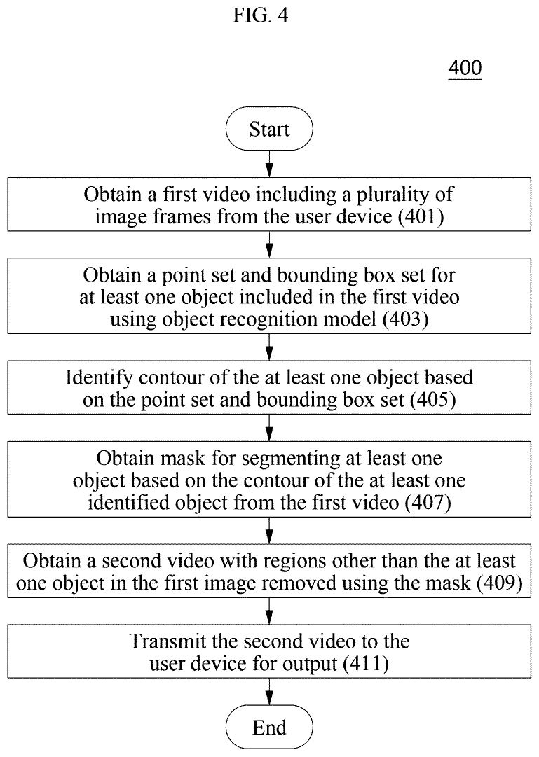

FIG. 4 is a flowchart 400 illustrating operations of the electronic device for generating a video in which regions other than at least one object are removed, according to various embodiments. FIG. 5 is a flowchart 500 illustrating operations of the electronic device for grouping multiple image frames in a video obtained from a user device and acquiring the contour of at least one object, according to various embodiments.

Each of the operations described below may be performed in combination with each other. In addition, an operation by the electronic device 200 (e.g., the electronic device 106 of FIG. 1) among the operations described below may mean an operation by the processor 210 of the electronic device 200.

Additionally, the term “information” described below may be interpreted as meaning “data” or “signal,” where “data” can be understood as a concept encompassing both analog data and digital data.

According to various embodiments, the operations illustrated in FIGS. 4 and 5 are not limited to the illustrated order, but may be performed in various orders. In addition, according to various embodiments, more operations may be performed or fewer operations may be performed than the operations illustrated in FIGS. 4 and 5.

Descriptions of operations of the electronic device 200 according to various embodiments that overlap with or are similar to the aforementioned explanations may be omitted.

Referring to FIG. 4, the electronic device 200 may obtain a first video comprising a plurality of image frames from a user device (e.g., the user device 102 in FIG. 1), in operation 401. For example, the first video may include a series of image frames with a temporal flow, as well as video data corresponding to the plurality of image frames, including audio information and subtitle information.

According to various embodiments, in operation 403, the electronic device 200 may utilize an object recognition model (e.g., the object recognition model included in the object recognition module (305) in FIG. 3) to obtain a set of points and a set of bounding boxes for at least one object included in the first video. For example, the electronic device 200 may input the first video into the object recognition model stored in a storage device (e.g., the storage device 220 in FIG. 2) and obtain the first set of points and the first set of bounding boxes generated by recognizing at least one object in each of the plurality of image frames of the first video as output from the object recognition model. According to various embodiments, the object recognition model may be a model trained to detect and track at least one object included in a video, and to output a set of points and a set of bounding boxes by extracting skeleton data for the at least one object.

In operation 405, the electronic device 200 may identify the contour of at least one object based on the set of points and the set of bounding boxes. For example, the electronic device 200 may apply both the set of points extracted as skeleton data for the at least one object included in the first video and the set of bounding boxes including at least one bounding box for the at least one object, to identify the contour of the at least one object.

According to various embodiments, in operation 407, the electronic device 200 may obtain mask for segmenting at least one object based on the contour of the at least one object identified from the first video. For example, the electronic device 200 may obtain mask for segmenting the at least one object for each of the plurality of image frames of the first video.

According to various embodiments, the electronic device 200 may obtain multiple masks for segmenting at least one object based on the contour of the at least one object and determine the mask by evaluating the reliability of the multiple masks. For example, the electronic device 200 may obtain multiple masks and reliability values corresponding to each of the multiple masks, and determine the mask with the highest reliability value as the mask corresponding to the image frame.

According to various embodiments, in operation 409, the electronic device 200 may obtain a second video from which a region excluding the at least one object of the first video is removed using the mask. For example, the electronic device 200 may obtain a second video from which the region excluding the at least one object is removed for each of the plurality of video frames of the first video using the mask for each of the plurality of video frames of the first video.

According to various embodiments, in operation 411, the electronic device 200 may transmit the second video to the user device for output. For example, the electronic device 200 may transmit the second video to the user device 102 via the communication device 230.

Referring to FIG. 5, the electronic device (200) may obtain a first video comprising a plurality of image frames from the user device in operation 501, similarly to operation 401.

According to various embodiments, in operation 503, the electronic device 200 may generate video frame groups by grouping the plurality of video frames into pre-determined reference units.

According to various embodiments, the electronic device 200 may recognize the scene change of the first video using the object recognition model. For example, the electronic device 200 may identify at least one object included in each of the plurality of video frames of the first video using the object recognition model, and may recognize the scene change based on at least one of the change of the at least one object, the change of the type of the at least one object, the change of the number of the at least one object, the change of the main color value of each of the plurality of video frames, the audio information of the first video, the subtitle information of the first video, the order information of the plurality of video frames, the photographing time information of each of the plurality of video frames, and the user input for video frame grouping. In addition, the video frame groups may be generated by grouping the plurality of video frames of the first video based on the basis of the scene change.

According to various embodiments, in operation 505, the electronic device 200 may utilize an object recognition model to track at least one object for each group of image frames and obtain a set of points and a set of bounding boxes. For example, the electronic device 200 may track at least one object for each group of image frames to obtain the set of points and the set of bounding boxes more quickly and with higher accuracy. According to various embodiments, when obtaining the set of points and the set of bounding boxes for each of the plurality of image frames, the electronic device 200 may map and store identification information for the image frame groups corresponding to the set of points and the set of bounding boxes, along with the sequence information of the image frames. According to various embodiments, the electronic device 200 may perform operations 403 through 411 using the set of points and the set of bounding boxes obtained in operation 505.

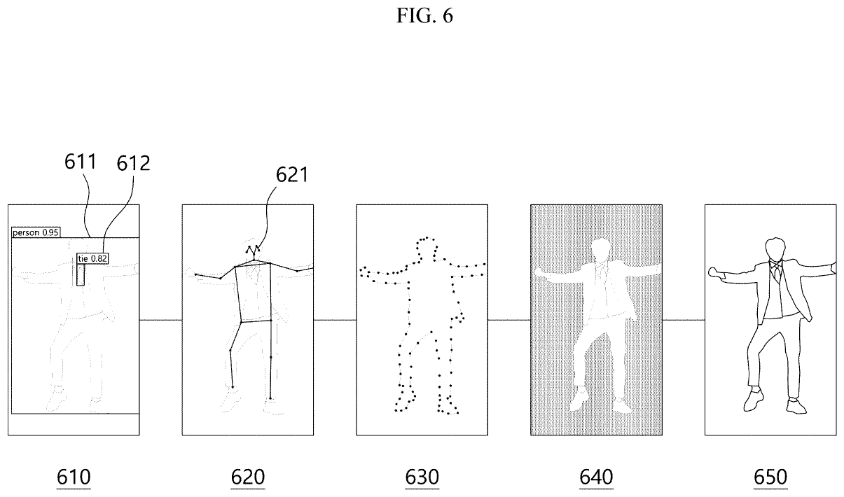

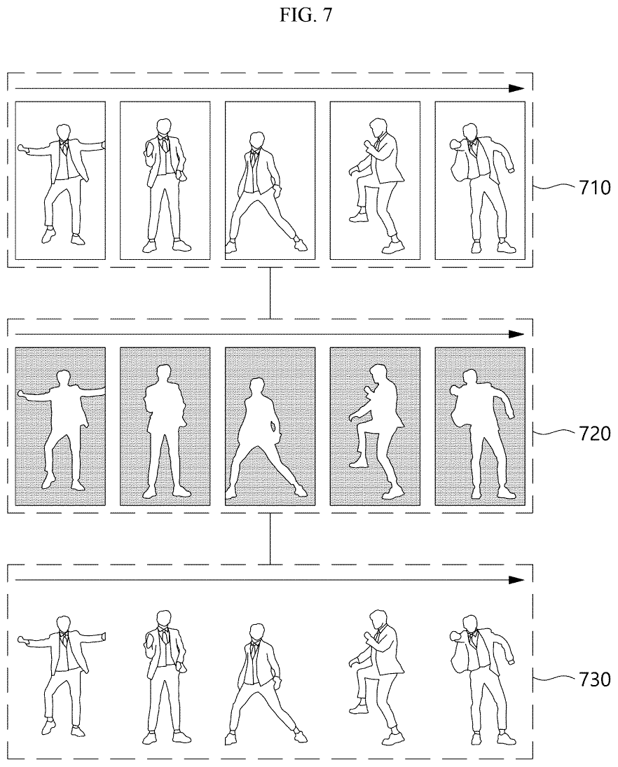

FIG. 6 is a diagram for describing mask generated by an electronic device according to variousous embodiments. FIG. 7 is a diagram for describing video from which background is removed based on the mask generated by an electronic device according to various embodiments.

Referring to FIG. 6, a diagram is shown illustrating the electronic device (200) obtaining a first edited image frame by removing the remaining regions except for at least one object from one first original image frame among the plurality of image frames of the first video.

Referring to FIG. 7, a diagram is shown illustrating the electronic device (200) obtaining a mask for the first video comprising a plurality of image frames and acquiring a second video by removing the remaining regions except for at least one object based on the mask.

According to various embodiments, the electronic device 200 may obtain a point set and a bounding box set for at least one object included in a plurality of video frames included in a first video obtained from the user device.

For example, the electronic device 200 may obtain a bounding box set 610 for the first original image frame among the plurality of image frames included in the first video by using the object recognition model. For instance, the object recognition model may identify a tie object and a person object included in the first original image frame. Accordingly, the bounding box set 610 may include a bounding box 611 for the person object and a bounding box 612 for the tie object.

For example, the electronic device 200 may obtain the point set 620 for the first original video frame among the plurality of video frames included in the first video using the object recognition model. For example, the object recognition model may obtain key-points 621 for each skeleton data by extracting and tracking skeleton data for a person included in the first original video frame.

According to various embodiments, the electronic device 200 may identify a contour 630 of at least one object (e.g., a person) included in the first original image frame based on the bounding box set 610 and the point set 620 obtained using the object recognition model. According to various embodiments, the electronic device 200 may utilize both the bounding box set (610) and the point set 620 for the at least one object (e.g., a person) to more accurately identify the contour 630 of the at least one object.

According to various embodiments, the electronic device 200 may obtain a mask 640 that segments the at least one object (e.g., a person) based on the contour 630 of the first original image frame. Using the mask, a first edited image frame 650 from which the region except for the at least one object (e.g., a person) of the first original image frame is removed may be obtained.

According to various embodiments, the electronic device 200 may obtain a second video in which a region excluding at least one object is removed from each of a plurality of image frames included in the first video through a method similar to that generated the first edition image frame 650.

For example, the electronic device 200 may obtain masks 720 for each of the first image frames 710 including a plurality of image frames included in the first video. In addition, the electronic device 200 may obtain second image frames 730 including a plurality of image frames from which regions except for at least one object are removed from each of the first image frames 710 based on the masks 720.

According to various embodiments, the electronic device (200) may obtain a second video by performing an encoding operation on the second video frames (730) to include audio information and/or subtitle information corresponding to the first video.

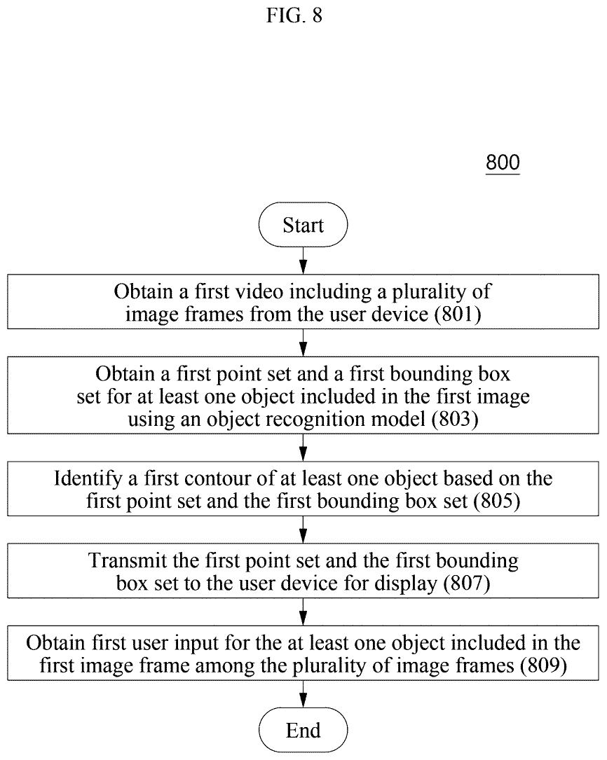

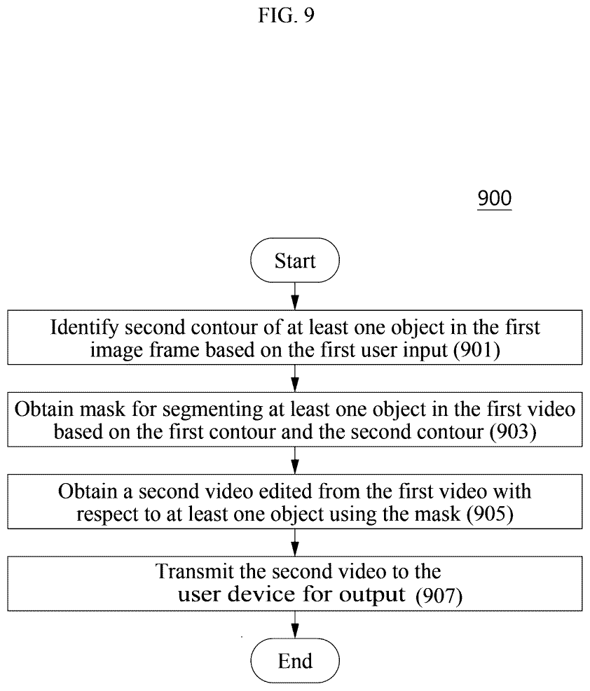

FIG. 8 is a flowchart 800 illustrating operations of the electronic device for obtaining user input regarding the contour of at least one object generated using an object recognition model, according to various embodiments. FIG. 9 is a flowchart 900 illustrating operations of the electronic device for generating an edited video related to at least one object based on user input, according to various embodiments.

The operations described below may be performed in combination with one another. Additionally, the operations described below, when performed by the electronic device 200 (e.g., the electronic device (106) in FIG. 1), may represent operations executed by the processor 210 of the electronic device 200.

Furthermore, the term “information” described below may be interpreted as meaning “data” or “signal,” where “data” encompasses both analog and digital data.

According to various embodiments, the operations shown in FIGS. 8 and 9 are not limited to the order shown, but may be performed in various orders. In addition, according to various embodiments, more operations may be performed or fewer operations may be performed than the operations illustrated in FIGS. 8 and 9.

Among the operations of the electronic device 200 according to various embodiments, descriptions duplicated or similar to those described above may be omitted.

Referring to FIG. 8, in operation 801, the electronic device 200 may obtain a first image including a plurality of image frames from a user device (e.g., the user device 102 of FIG. 1).

According to various embodiments, in operation 803, the electronic device 200 may obtain a first set of points and a first set of bounding boxes for at least one object included in the first video by using an object recognition model trained to extract a set of points and bounding boxes for objects included in a video.

According to various embodiments, in operation 805, the electronic device 200 may identify a first contour of at least one object based on the first set of points and the first set of bounding boxes.

According to various embodiments, in operation 807, the electronic device 200 may transmit the first set of points and the first set of bounding boxes to the user device for display. For example, the user device may overlay and display visual objects corresponding to the first set of points and the first set of bounding boxes for each of the plurality of image frames included in the first video via a display device.

According to various embodiments, in operation 809, the electronic device 200 may obtain a first user input for at least one object included in the first image frame among the plurality of image frames from the user device. For example, the electronic device 200 may obtain user input for at least one object displayed on the screen, which shows the first set of points and the first set of bounding boxes.

The user input may include various inputs related to the at least one object in the first image frame. For example, it may include at least one of selecting the at least one object, input for the point set of the at least one object, input for the bounding box of the at least one object, masking input for the point set of the at least one object, or text input related to selecting the contour of the at least one object.

Referring to FIG. 9, in operation 901, the electronic device 200 may identify a second contour of the at least one object in the first image frame based on the first user input. For example, the processor 210 may identify the contour of the at least one object in the first image frame among the plurality of image frames in the first video as the second contour based on the user input.

According to various embodiments, in operation 903, the electronic device 200 may obtain a mask for segmenting at least one object in the first video based on the first contour and the second contour. For example, the electronic device 200 may obtain a mask based on the second contour of the at least one object in the first image frame and the first contour of the at least one object in the remaining image frames included in the first video.

According to various embodiments, in operation 905, the electronic device 200 may obtain a second video edited for at least one object in relation to the first video using the mask. For example, the electronic device 200 may use mask obtained based on the first contour and the second contour to edit the first video for each of the plurality of image frames, thereby obtaining the second video in relation to the at least one object.

According to various embodiments, in operation 907, the electronic device 200 may transmit the second video to the user device for output. For example, the electronic device 200 may transmit the second video to the user device 102 via the communication device 230.

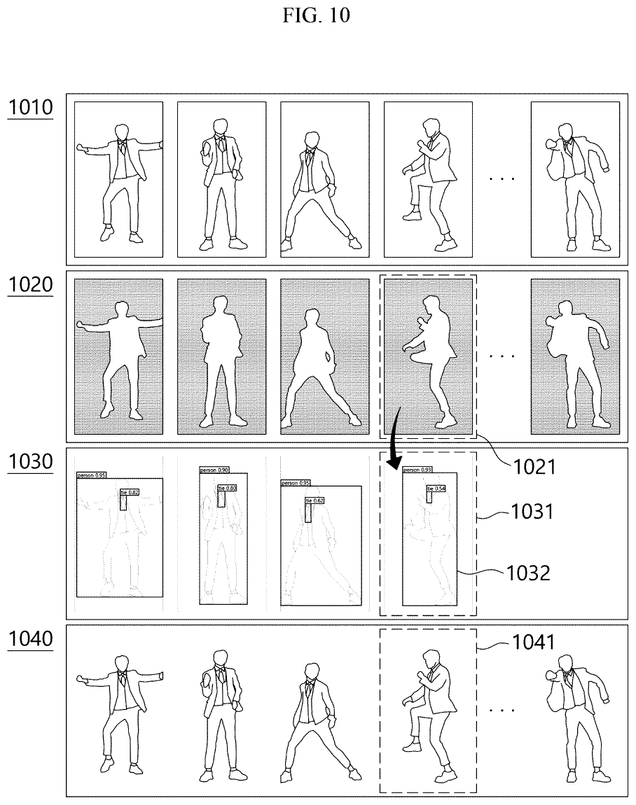

FIG. 10 is a diagram illustrating an edited video generated through a mask based on user input, according to various embodiments.

Referring to FIG. 10, the electronic device 200 (e.g., the electronic device 106 in FIG. 1) may obtain an original video 1010 comprising a plurality of image frames from the user device 102 in FIG. 1 (e.g., the first video in FIG. 8). According to various embodiments, the original video 1010 may consist of a plurality of image frames including a person (e.g., at least one object in FIG. 2).

According to various embodiments, the electronic device 200 may use an object recognition model (e.g., the object recognition model in FIG. 3) trained to extract a set of points and a set of bounding boxes for objects included in the video to obtain a first set of points and a first set of bounding boxes for at least one object.

According to various embodiments, the electronic device 200 may identify the contour of the person included in each of the plurality of image frames in the original video 1010 based on the first set of points and the first set of bounding boxes.

According to various embodiments, the electronic device 200 may obtain mask(s) for segmenting a person from each of a plurality of image frames within the original video 1010 based on the contour of the person identified from the original video 1010. For example, the electronic device 200 may obtain a first mask set 1020 that segments a person by a plurality of image frames of the original video 1010.

According to various embodiments, the electronic device 200 may transmit the first set of points and/or the first set of bounding boxes generated using the object recognition model to the user device 102 for display. For example, the user device 102 may overlay and display visual objects corresponding to the first set of points and/or the first set of bounding boxes for each of the plurality of image frames included in the original video 1010 via a display device. For instance, the user device 102 may display a video 1030 in which the visual objects are overlaid for each of the plurality of image frames in the original video 1010.

Meanwhile, according to various embodiments, editing may be required for the contours of the person identified using the object recognition model. For example, if there is a discrepancy between the actual contour of the person in the first image frame of the original video 1010 and the contour obtained through the object recognition model, adjustments to the contour of the person in the first image frame may be necessary. Furthermore, editing may also be required for the first mask 1021 generated based on the contour requiring adjustment.

According to various embodiments, the user may determine that it is necessary to modify the contour of the person of the first video frame through the video 1030 overlapping the visual object for each of the plurality of video frames. In this case, the user may perform a user input operation for the person included in the first video frame 1031 among the plurality of video frames of the video 1030 overlapping the visual object. For example, the user device 102 may obtain a bounding box setting input for a person in the first video frame 1031. Accordingly, the user device 102 may display video in which the bounding box 1032 set by the user overlaps the first video frame 1031 through the display device.

According to various embodiments, the electronic device 200 may identify the editing contour of the at least one object of the first video frame based on the user input. For example, the electronic device 200 may identify the editing contour of the person in the first video frame based on the bounding box setting input.

According to various embodiments, the electronic device 200 may obtain a mask for segmenting the person in the first image frame based on the edited contour. Additionally, the electronic device 200 may obtain a edited mask set based on the edited contour of the person in the first image frame and the contours of at least one object in the remaining image frames included in the original video 1010.

According to various embodiments, the electronic device 200 may obtain an edited video 1040 by editing the original video 1010 in relation to the person using the edited mask set. For example, the electronic device 200 may obtain an edited video 1020 by using the edited masks to edit the original video 1010 for each of the plurality of image frames in relation to the person. For instance, the electronic device 200 may obtain an edited video 1040 by removing the background from the original video 1010 while retaining the person.

According to various embodiments, the electronic device 200 may transmit the editing video 1040 to the user device 102 so that the user device 102 outputs the editing video 1040. Therefore, the user device 102 may display the editing video 1040 through the display device.

According to various embodiments, the electronic device (200) may identify at least one contour with higher accuracy by utilizing user input for the contour of at least one object obtained using the object recognition model. As a result, it is possible to obtain a video that more accurately reflects the user's intent with respect to the original video.

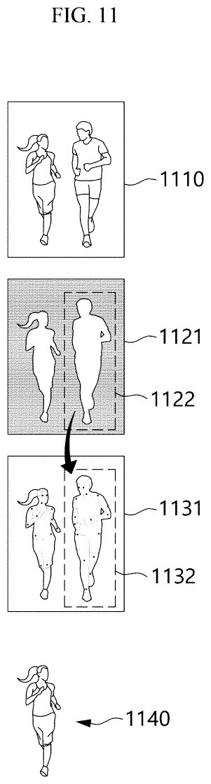

FIG. 11 is a diagram for describing video edited through mask generated by an electronic device based on a user input according to various embodiments.

According to various embodiments, the user input for the at least one object in the video frame may include various inputs. For example, the electronic device 200 may include at least one of an input for selecting the at least one object, an input for a point set of the at least one object, an input for a bounding box of the at least one object, masking input for a point set of the at least one object, and a text input related to selecting the contour of the at least one object.

Referring to FIG. 11, the user input illustrates the selection of at least one object among a plurality of objects included in an image frame.

According to various embodiments, the electronic device 200 (e.g., the electronic device 106 of FIG. 1) may obtain a first video including a plurality of image frames from the user device 102 of FIG. 1, and obtain a first point set and a first bounding box set for the at least one object using an object recognition model (e.g., the object recognition model of FIG. 3) trained to extract a point set and a bounding box set of the at least one object included in the first image. For example, the electronic device 200 may obtain a first video including a plurality of people, and obtain a first point set and a first bounding box set for the plurality of people included in the first image.

According to various embodiments, the electronic device 200 may identify the contours of multiple people included in each of the plurality of image frames based on the first set of points and the first set of bounding boxes. For example, the electronic device 200 may identify the contours of each of the multiple people included in the first image frame 1110.

According to various embodiments, the electronic device 200 may obtain mask(s) for segmenting the multiple people in each of the plurality of image frames based on the contours of the multiple people identified from the first video. For instance, the electronic device 200 may obtain a first mask 1121 for segmenting the multiple people included in the first image frame 1110.

According to various embodiments, the electronic device 200 may transmit the first point set and/or the first bounding box set generated using the object recognition model to the user device 102 so that the first point set and/or the first bounding box set are displayed. For example, the user device 102 may overlap and display visual objects for each of the first point set and/or the first bounding box set for each of the plurality of video frames included in the first video through the display device. For example, the user device 102 may display an video frame 1131 in which visual objects representing the first point set overlap each of the plurality of people included in the first video frame 1110 through the display device.

Meanwhile, according to various embodiments, editing may be needed for the contour of a person identified using the object recognition model. For example, if a user wants to obtain a video selecting only a specific person (e.g., removing all regions in the original video except for the specific person), editing may be needed for the contours of other people, excluding the specific person, among the contours of multiple people in each of the plurality of image frames of the first video. Accordingly, editing may also be needed for the mask region 1122 corresponding to the second person in the first mask 1121.

According to various embodiments, if the user wants to obtain a video selecting only a specific person (e.g., the first person) from the first video, the user may perform an input action for the person not to be selected in at least one image frame among the plurality of image frames in the first video. For example, the user device 102 may obtain user input for the region 1132 corresponding to the second person among the multiple people, including the first person and the second person, in the first image frame 1110. For instance, the user device 102 may obtain user input to deselect the point set for the second person.

According to various embodiments, the electronic device 200 may identify a edited contour for at least one object in the first image frame 1110 based on the user input. For example, the electronic device 200 may obtain a edited contour that retains only the contour of the first person among the multiple people in the first image frame 1110 based on user input to deselect the point set for the second person.

According to various embodiments, the electronic device 200 may obtain a mask for segmenting the first person in the first image frame 1110 based on the edited contour. For example, the electronic device 200 may obtain a edited mask based on the first mask 1121 for the first image frame 1110 and user input to deselect the second person. Furthermore, the electronic device 200 may perform similar operations for the mask set of each image frame in the plurality of image frames in the first video, thereby obtaining a mask set that segments only the first person.

According to various embodiments, the electronic device 200 may obtain the edition image frame 1140 by removing the remaining region except for the first person from among the plurality of people of the first image frame 1110 using the editing mask. The electronic device 200 may obtain a second video (e.g., the second video of FIG. 9) by removing the remaining area except for the first person from the first video through a similar method.

According to various embodiments, the electronic device 200 may transmit the second video to the user device 102 so that the user device 102 can output the second video. Consequently, the user device 102 may display the second video via its display device.

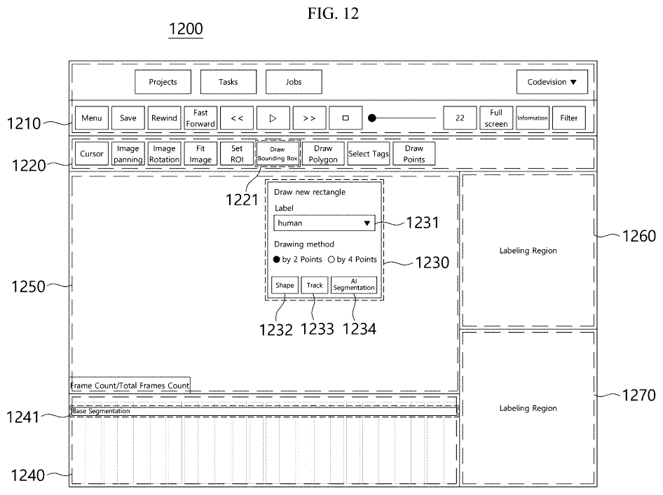

FIG. 12 shows an execution screen output through a user device according to various embodiments.

Referring to FIG. 12, the user device 102 may display an execution screen related to a video editing service based on control signals obtained from the electronic device 200. The execution screen 1200 of the video editing service displayed via the user device may include a first region 1210, a second region 1220, a third region 1230, a fourth region 1240, a fifth region 1250, and/or a sixth region 1260.

In this document, icons may be replaced with representations such as buttons, menus, or objects. Additionally, the icons shown in the first region 1210, second region 1220, third region 1230, fourth region 1240, fifth region 1250, and/or sixth region 1260 in FIG. 12 are exemplary and may be rearranged, replaced with other icons, or omitted as needed.

According to various embodiments, the user device 102 may display the execution screen 1200 based on the control signals from the electronic device 200. The execution screen 1200 may include the first region 1210, which contains icons related to video playback functions (e.g., rewind, fast forward), menu icons for selecting various functions provided by the video editing service, and a save icon for storing the video editing executed via the electronic device 200. The electronic device 200 may execute video editing functions based on user input obtained through the first region 1210 of the user device 102.

According to various embodiments, the execution screen 1200 may include a second region 1220 related to user input requesting edits for at least one object in the video. For example, the user device 102 may obtain user input through the icons displayed in the second region 1220, as described with reference to FIGS. 8 through 9. The execution screen 1200 may include various icons arranged in the second region 1210, such as icons for executing image movement and/or rotation functions for image frames, icons 1211 related to bounding box input for at least one object within an image frame, and icons for inputting points related to at least one object.

According to various embodiments, if user input for the icon 1211 related to bounding box input is obtained, a third region 1230 for executing functions related to drawing bounding boxes may additionally be displayed. For example, the third region 1230 may include a menu icon 1231 for selecting the type of object within the image frame (i.e., choosing a label to improve object recognition), an icon 1232 for drawing bounding boxes on a single image frame, an icon 1233 for drawing bounding boxes on multiple image frames, and an icon 1234 for drawing bounding boxes using prompt input and segmentation input. According to various embodiments, if the icon 1234 is selected, both the output of the bounding box set generated using the object recognition model and user input for bounding box input, as described with reference to FIGS. 2 through 9, may be utilized.

According to variousous embodiments, the execution screen 1200 may include a fourth region 1240 for displaying a time line for the visual object 1231 for the plur in the uploaded video, a fifth region 1250 for displaying a label for the object in the image, a sixth region 1260 for displaying a label for the object in the image, and/or a seventh region 1270 for displaying a label for the object in the image.

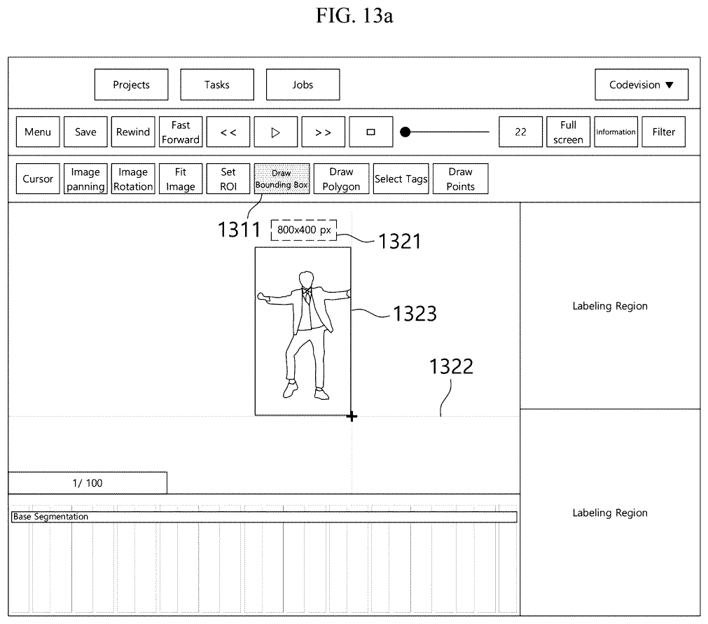

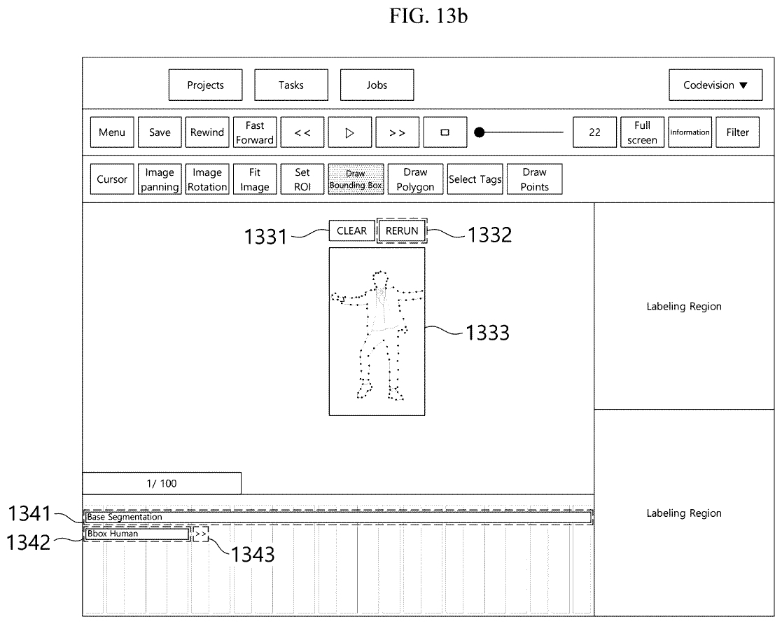

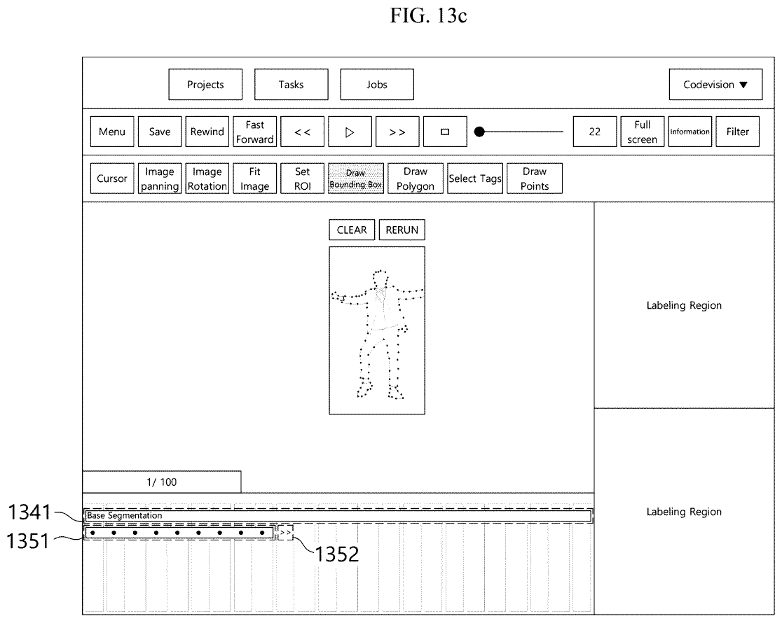

FIG. 13A illustrates an execution screen of a user input for a bounding box output through a user device according to various embodiments.

FIG. 13B shows an execution screen of a user input for a bounding box output through a user device according to various embodiments.

FIG. 13C shows an execution screen output through a user device as a user input for a bounding box is obtained according to various embodiments.

Hereinafter, the execution screens illustrated can be understood as screens displayed through the user device 102, controlled by the electronic device 200.

Referring to FIG. 13A, as the first video is obtained through the user device 102, the electronic device 200 may control the user device 102 to display visual objects for the plurality of image frames of the first video in the fourth region 1240, as described with reference to FIG. 12. Additionally, the electronic device 200 may control the user device 102 to display the visual object for the image frame selected based on user input in the fifth region 1250.

According to various embodiments, when the first image frame 1323 is selected from among the plurality of image frames in the first video uploaded through the user device 102 and the user input for the icon 1311 related to the bounding box input is obtained, the electronic device 200 may display the pixel information 1321 for the first image frame 1323 and the first image frame 1323 in the fifth region 1250. In this case, the user device 102 may additionally display a horizontal and/or vertical straight line 1322 that may assist the bounding box input in the fifth region 1250.

Referring to FIG. 13B, if user input related to bounding box input for the first image frame 1323 is obtained through the user device 102, the electronic device 200 may obtain inputs related to bounding box settings through the user device. For example, when a user intends to select a bounding box for at least one object within the first image frame 1323 displayed in the fifth region 1250, they can input the bounding box using a start click and drag-and-drop motion. Accordingly, the electronic device 200 can identify the region of the bounding box selected by the user based on the (x, y) coordinates of the start click point and the (x, y) coordinates where the drop event occurs. The bounding box region identified through the user input may be displayed as a visual object 1333 for the bounding box, overlaid on the first image frame 1323 displayed in the fifth region 1250.

According to various embodiments, as user input is obtained, the user device 102 may display an icon 1331 in the fifth region 1250 to indicate that the bounding box input has been completed, as well as an icon 1332 to allow the user to proceed with additional bounding box inputs or repeat the same input.

According to various embodiments, as the user input for the bounding box is obtained, the user device 102 may display the visual object 1342 representing the image frames corresponding to the user input in association with the visual object 1341 representing the plurality of image frames in the first video displayed in the fourth region 1240. For example, the electronic device 200 may group the plurality of video frames 1341 and control the visual object 1342 representing the video frames of the first video frame group including the video frame corresponding to the user input to be displayed. In addition, the electronic device 200 may control the icon 1343 related to the function execution applied to the video frame group following the first video frame group to be displayed in the fourth region 1240.

Referring to FIG. 13C, an execution screen displayed through the user device 102 is illustrated as user input for the icon 1343 is obtained.

According to various embodiments, the electronic device 200 may obtain user input for selecting a bounding box for at least one object within an image frame through the user device 102 and obtain user input for the icon 1343 related to executing a function that applies the obtained user input to subsequent image frame groups following the first image frame group.

According to various embodiments, if user input for the icon 1343 is obtained, the electronic device 200 may apply the bounding box input for at least one object to the subsequent image frame groups following the first image frame group and control the display of a visual object 1351 indicating the image frame groups to which the bounding box input has been applied. Additionally, the electronic device 200 may control the display of an icon 1352 in the fourth region 1240, which performs a function similar to that of the icon 1343.

According to various embodiments, a user can input a bounding box for at least one object in a specific image frame and apply the input to multiple image frames (e.g., subsequent image frames) as is.

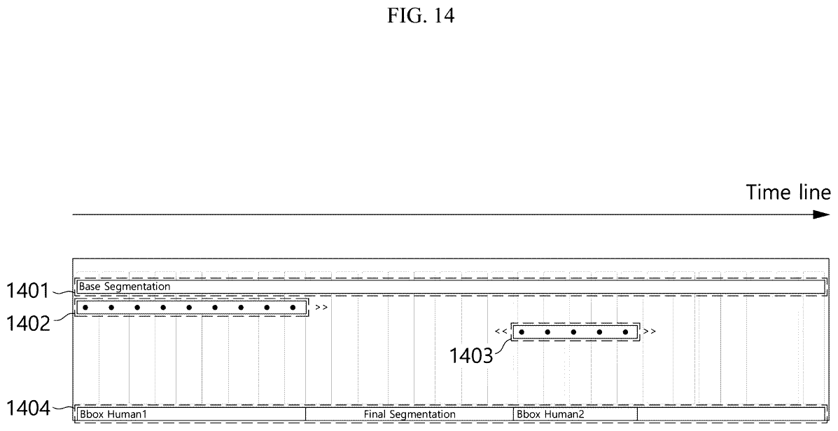

FIG. 14 is a diagram for explaining that an electronic device applies a user input according to various embodiments.

Referring to FIG. 14, a visual object representing the plurality of video frames displayed in the fourth region 1240 described with reference to FIG. 12 is illustrated.

According to various embodiments, the electronic device 200 may display a visual object 1401 representing the plurality of image frames within the first video obtained through the user device 102. Additionally, the electronic device 200 may identify a first contour for at least one object in the plurality of image frames using the object recognition model described with reference to FIG. 3. The first contour obtained for each of the plurality of image frames using the object recognition model can be understood as a base segment 1401.

According to various embodiments, the electronic device 200 may obtain the user input for selecting the bounding box for at least one object for the specific video frame(s) from among the plurality of video frames. For example, the electronic device 200 may obtain the user input for selecting the bounding box for the video frames in the first video group and the second video group among the video groups having grouped the plurality of video frames. The electronic device 200 may identify the second contour for at least one object of the video frames in the first video group and the second video group based on the user input. The second contoured for each of the image frames in the first image group and the second image group may be understood as the first user selection segment (Bbox Human1) 1402.

According to various embodiments, the electronic device 200 may obtain a second user-selected segment (Bbox Human2) 1403 in a manner similar to the first user-selected segment 1402. For example, the electronic device 200 may obtain user input for selecting a bounding box for at least one object in the third image group among the plurality of image frames and identify a third contour for the at least one object based on the user input.

According to various embodiments, the electronic device 200 may obtain the final segment 1404 for distinguishing the at least one object of the first video based on the first contour, the second contour, and/or the third contour. According to various embodiments, the electronic device 200 may generate mask obtained by distinguishing the at least one object for each of the plurality of image frames in the first video based on the final segment.

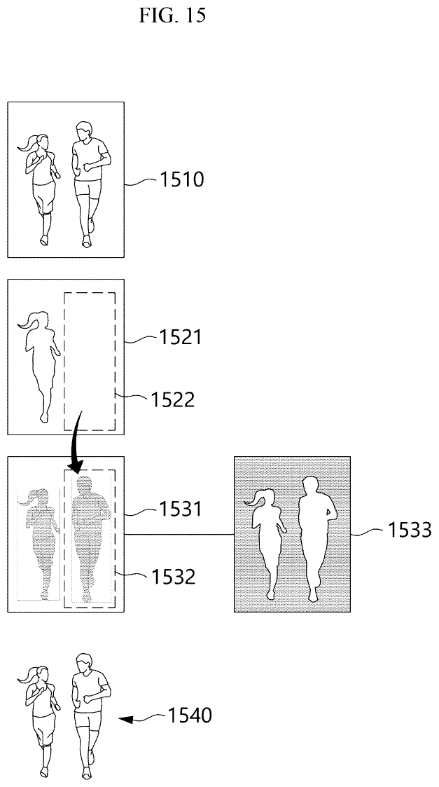

FIG. 15 is a diagram for describing the generation of the mask electronic device when the user input for the bounding box is the object addition input according to various embodiments.

Referring to FIG. 15, user input for selecting a bounding box, as described with reference to FIGS. 13A through 13B, is illustrated as user input for selecting at least one object among multiple objects included in an image frame.

According to various embodiments, the electronic device 200 may obtain a first video including a plurality of image frames from the user device 102, and obtain a first set of points and a first set of bounding boxes for at least one object using an object recognition model (e.g., the object recognition model of FIG. 3) that is trained to extract a set of points and a set of bounding boxes of at least one object included in the first image. For example, the electronic device 200 may obtain a first video including a plurality of people, and obtain a first set of points and a first set of bounding boxes for a first person among the plurality of people included in the first video.

According to various embodiments, the electronic device 200 may identify the contour of at least one object included in each of the plurality of video frames based on the first set of points and the first set of bounding boxes. For example, the electronic device 200 may identify the contour of the first person among the plurality of people included in the first video frame 1510.

According to various embodiments, the electronic device 200 may obtain masks for segmenting the first person in each of the plurality of image frames based on the contour of the first person identified from the first video. For example, the electronic device 200 may obtain a first mask 1521 for segmenting the first person among the multiple people included in the first image frame 1510. Since the contour of the second person among the multiple people in the first image frame 1510 is not identified, the region 1522 corresponding to the second person in the first mask 1521 may not be segmented.

According to various embodiments, the electronic device 200 may transmit the first set of points and/or the first set of bounding boxes generated using the object recognition model to the user device 102 for display. For instance, the user device 102 may overlay and display visual objects corresponding to the first set of points and/or the first set of bounding boxes for each of the plurality of image frames included in the first video via the display device. For example, the user device 102 may display an image frame with visual objects overlaid to represent the bounding box set for the first person among the multiple people included in the first image frame 1510.

According to various embodiments, the electronic device 200 may obtain a user input to select not only the first person but also the second person among the plurality of people included in the first video frame 1510 through the user device 102. For example, the electronic device 200 may obtain a user input to add the bounding box 1532 for the second person.

According to various embodiments, the electronic device 200 may identify the edited contour of at least one object of the first video frame 1510 based on the user input. For example, the electronic device 200 may obtain the edited contour including the contour of the second person in addition to the contour of the first person based on the user input to add the second person.

According to various embodiments, the electronic device 200 may obtain the edited mask 1533 for segmentation the first person and the second person from the first video frame 1510 based on the edited contour.

According to various embodiments, the electronic device 200 may obtain an edited image frame 1540 by using the edited mask to remove regions other than the first person and the second person among the multiple people in the first image frame 1510.

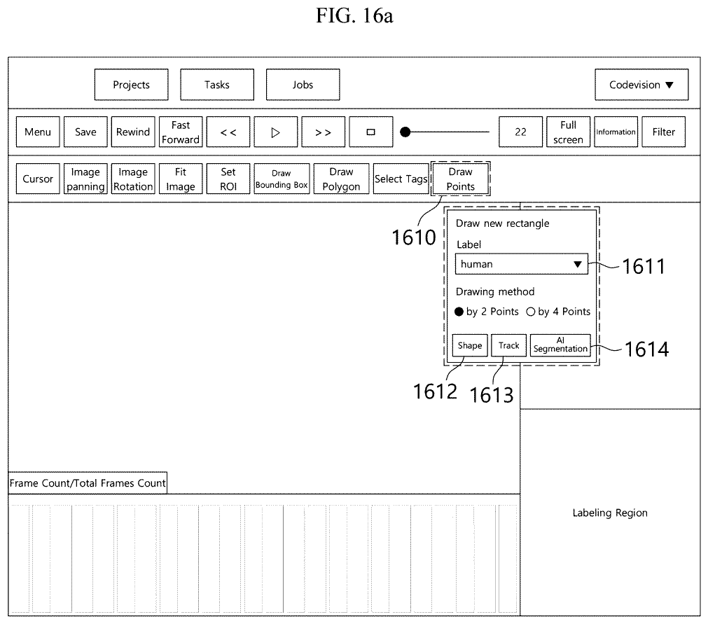

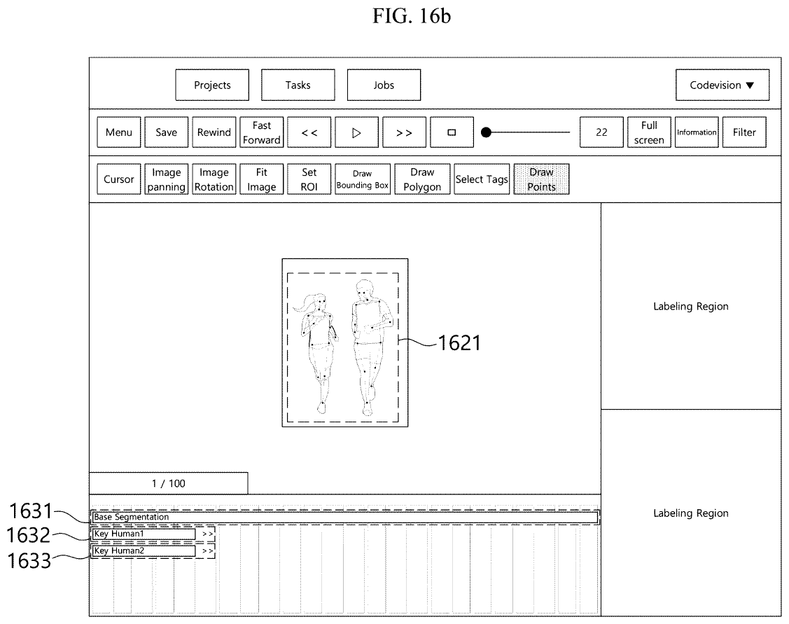

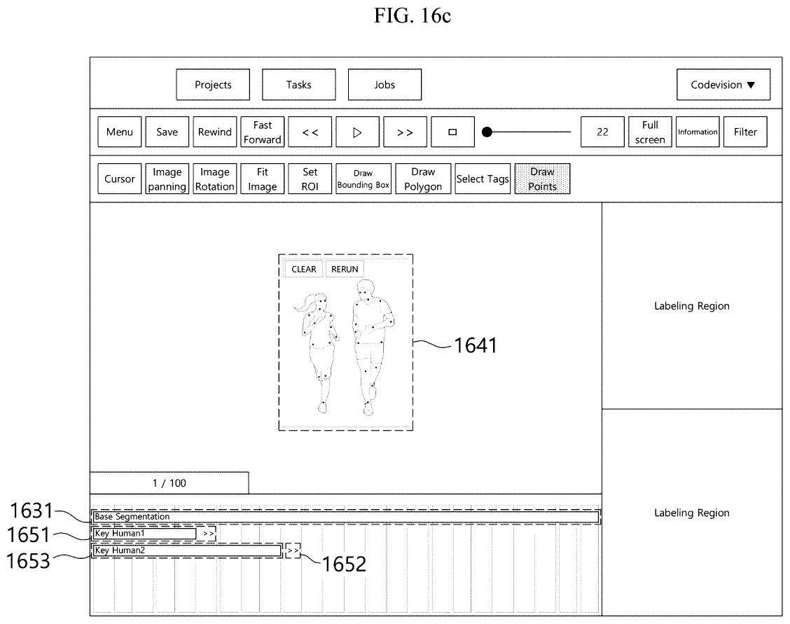

FIG. 16A illustrates an execution screen of a user input for a key-point output through a user device according to various embodiments. FIG. 16B illustrates an execution screen of a user input for a key-point output through a user device according to various embodiments. FIG. 16C illustrates an execution screen output through a user device as a user input for a key-point is obtained according to various embodiments.

Referring to FIG. 16A, as the first video is obtained through the user device 102, the electronic device 200 may control the user device 102 to display visual objects for the plurality of image frames of the first video in the fourth region 1240, as described with reference to FIG. 12. Additionally, the electronic device 200 may control the user device 102 to display the visual object for the selected image frame, based on user input, in the fifth region 1250.

According to various embodiments, if user input for the icon 1610 related to key-point selection input is obtained concerning the first video uploaded through the user device 102, the electronic device 200 may control the user device to additionally display icons for executing functions related to drawing key-points. For example, the icons may include a menu icon 1611 for selecting the type of at least one object within an image frame (i.e., selecting a label to improve object recognition), an icon 1612 for inputting key-points into a single image frame, an icon 1613 for inputting key-points into multiple image frames, and an icon 1614 for drawing key-points using prompt input and segmentation input. According to various embodiments, if the icon 1614 is selected, both the point set generated using the object recognition model and the point set obtained through user input, as described with reference to FIGS. 2 through 9, can be utilized.

Referring to FIG. 16B, if user input related to key-point input for the first image frame 1621 is obtained through the user device 102, the electronic device 200 may acquire input related to key-point settings through the user device. For example, when the user inputs a key-point for at least one object within the first image frame 1621 displayed in the fifth region 1250, they may input the key-point through a point click, or a point click and drag-and-drop motion. Accordingly, the electronic device 200 may identify the key-point selected by the user based on the (x, y) coordinates of the click input for a new point or the click and drag-drop event for moving an existing point. The key-point identified through user input may be displayed as a visual object for the key-point, overlaid on the first image frame 1621 displayed in the fifth region 1250.

According to various embodiments, as user input for the key-point is obtained, the user device 102 may display a visual object 1631 in the fourth region 1240 indicating the identification of at least one object in the plurality of image frames using the object recognition model, a visual object 1632 for the first object recognition based on the key-point user input for the first image frame 1621, and a visual object 1633 for the second object recognition. For example, the electronic device 200 may group the plurality of image frames and control the display of a visual object 1632 for the first object recognition in the first image frame group containing the image frame corresponding to the user input, as well as a visual object 1633 for the second object recognition. Meanwhile, the user device 102 may display an icon related to executing a function that applies the obtained user input, as described with reference to FIGS. 13B and 13C, to image frame groups subsequent to the first image frame group.

Referring to FIG. 16C, an execution screen displayed through the user device 102 is shown as the user input for the icon is obtained.

According to various embodiments, the electronic device 200 may obtain a user input for selecting a key-point for at least one object (e.g., the second object) in an video frame through the user device 1020, and obtain a user input for an icon 1652 related to execution of a function to apply the obtained user input to an video frame group subsequent to the first video frame group.

According to various embodiments, if user input for the icon 1652 is obtained, the electronic device 200 may apply the key-point input for at least one object to subsequent image frame groups following the first image frame group and display a visual object 1652 for the second object recognition to which the key-point input has been applied. Meanwhile, since the key-point input is only extended to the second object, the visual object 1651 for the first object recognition based on the key-point input for the first object in the first image frame group may remain unchanged.

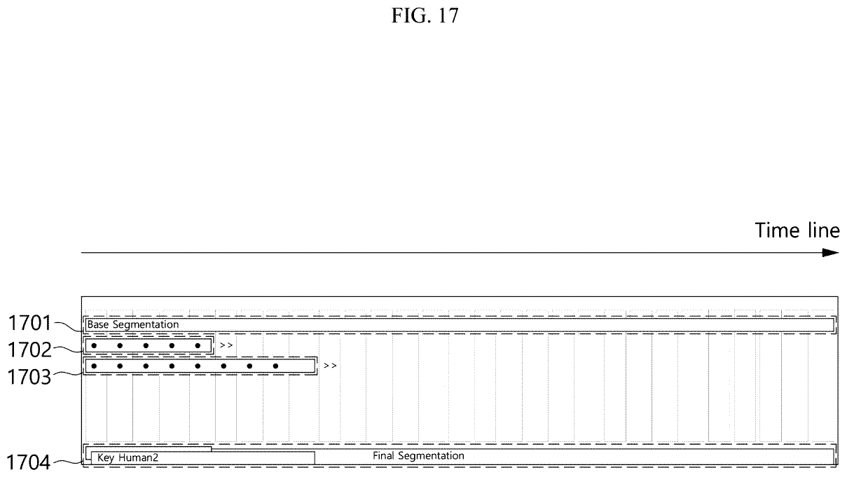

FIG. 17 is a diagram for describing the application of a user input by an electronic device according to various embodiments.

Referring to FIG. 17, visual objects representing the plurality of image frames displayed in the fourth region 1240, as described with reference to FIG. 12, and object recognition for the plurality of image frames are illustrated.

According to various embodiments, the electronic device 200 may display visual objects representing the plurality of image frames within the first video obtained through the user device 102. Additionally, the electronic device 200 may identify a first contour for at least one object in the plurality of image frames using the object recognition model described with reference to FIG. 3. The first contour obtained for each of the plurality of image frames using the object recognition model can be understood as a base segment 1701.

According to various embodiments, the electronic device 200 may obtain user input for selecting points (e.g., joints, skeleton data, etc.) of at least one object in certain image frames among the plurality of image frames. For example, the electronic device 200 may obtain user input for selecting points for the first object and the second object in the image frames of the first image group, which is among the grouped image groups of the plurality of image frames. Based on the user input, the electronic device 200 may identify the contours of at least one object in each image frame within the first image group (or the group where additional points were input for a specific object). For instance, the electronic device 200 may identify a second contour for the first object in the image frames of the first image group and a third contour for the second object in the image frames of the first image group and the second image group. The second contour obtained for each image frame in the first image group can be understood as the first user-selected segment (Key Human1) 1702. The third contour obtained for each image frame in the first image group and the second image group can be understood as the second user-selected segment (Key Human2) 1703.

According to various embodiments, the electronic device 200 may obtain a final segment 1704 for distinguishing at least one object of the first video based on the first contour, the second contour, and/or the third contour. According to various embodiments, the electronic device 200 may generate mask for segmentation at least one object for each of a plurality of image frames in the first video based on the final segment.

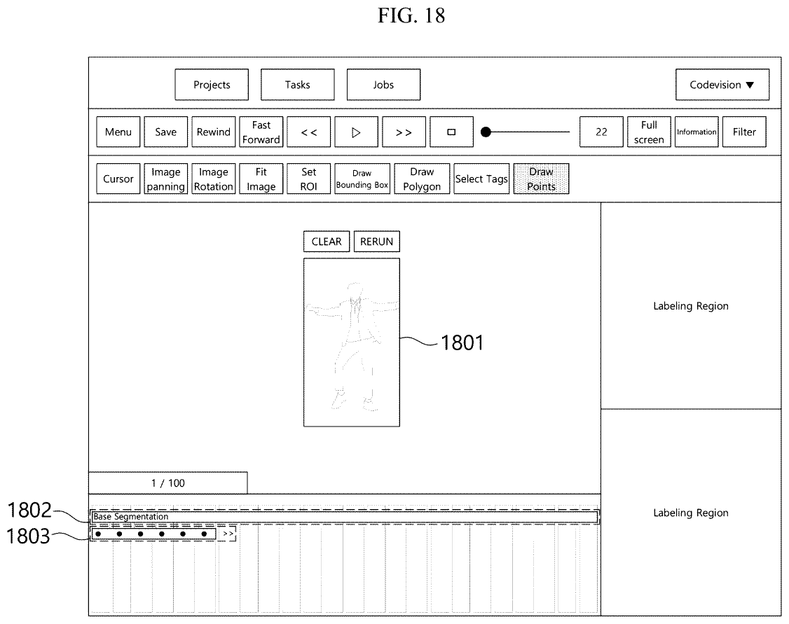

FIG. 18 illustrates an execution screen of a user input for mask outputted through a user device according to various embodiments.

Referring to FIG. 18, as the first video is obtained through the user device 102, the electronic device 200 may control the user device 102 to display visual objects for the plurality of image frames of the first video in the fourth region 1240, as described with reference to FIG. 12. Additionally, the electronic device 200 may control the user device 102 to display the visual object for the selected image frame, based on user input, in the fifth region 1250.

According to various embodiments, the electronic device 200 may display a visual object representing a plurality of image frames in a first video obtained through the user device 102. In addition, the electronic device 200 may identify a first contour for at least one object using the object recognition model described with reference to FIG. 3 for the plurality of video frames. The first contour obtained for each of the plurality of video frames using the object recognition model may be understood as a base segment 1802.

According to various embodiments, the electronic device 200 may obtain user input for directly inputting a mask (hereinafter referred to as “mask input”) for at least one object in specific image frames among the plurality of image frames. For example, the electronic device 200 may obtain a mask input for at least one object in the first image frame 1801 among the plurality of image frames.

According to various embodiments, the electronic device 200 may obtain the mask input for the first image frame 1801 through the user device 102. For instance, the mask input may be obtained as an input directly selecting the region of at least one object within the first image frame 1801. Through the user's region selection input for the mask input, the electronic device 200 may identify the region of at least one object input by the user.

According to various embodiments, as the mask input is obtained, the user device 102 may display, in the fourth region 1240, a visual object 1802 indicating the identification of at least one object in the plurality of image frames using the object recognition model, and a visual object 1803 indicating the recognition of at least one object in the first image frame 1801 based on the mask input.

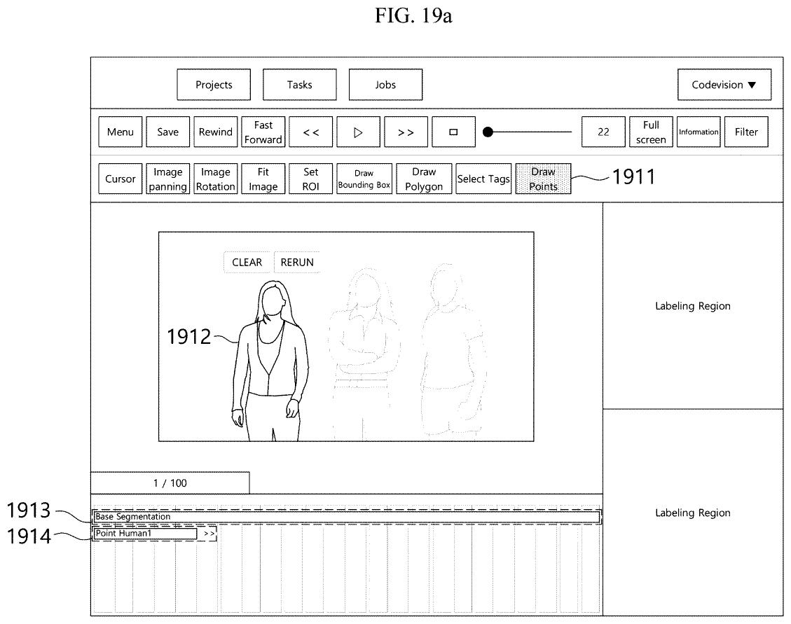

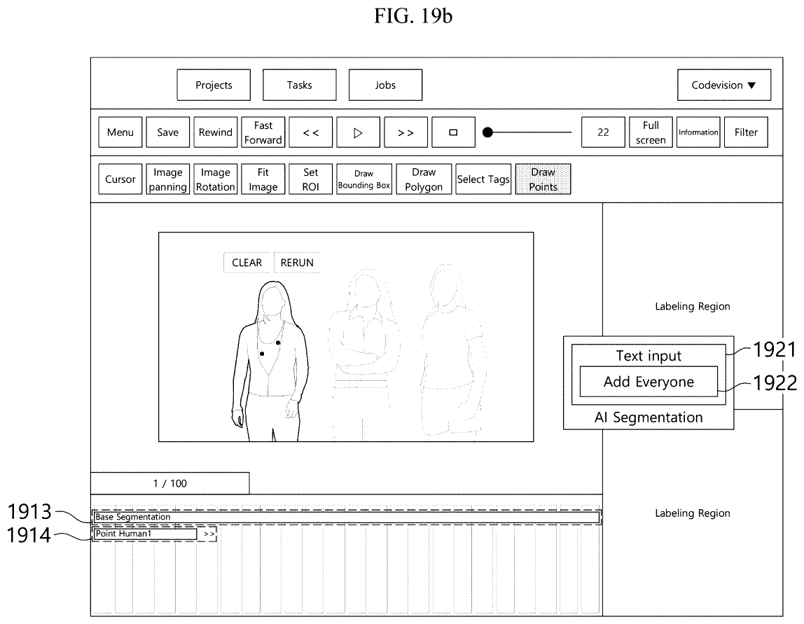

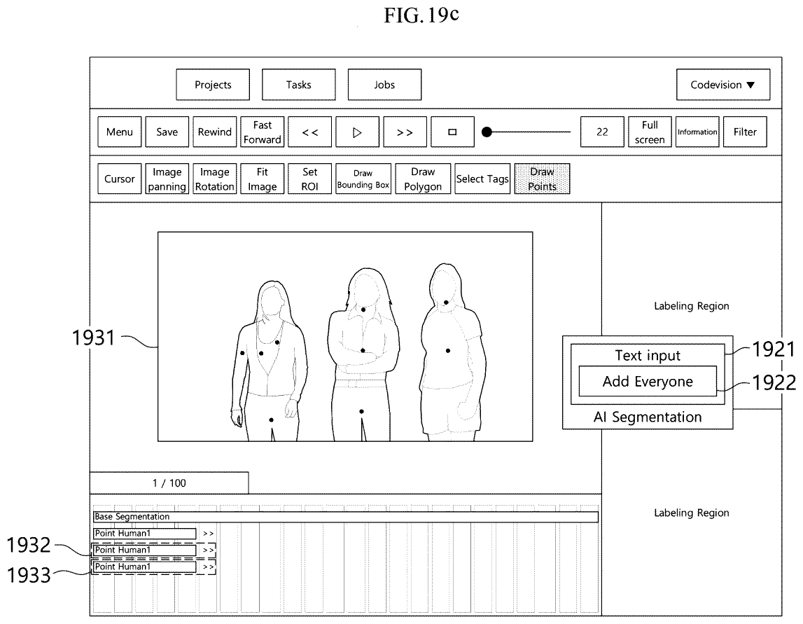

FIG. 19A illustrates an execution screen for user input selecting at least one object among multiple objects within an image frame, according to various embodiments. FIG. 19B illustrates an execution screen for text-based user input selecting at least one object among multiple objects within an image frame, according to various embodiments. FIG. 19C also illustrates an execution screen for text-based user input selecting at least one object among multiple objects within an image frame, according to various embodiments.

Referring to FIG. 19A, as the first video is obtained through the user device 102, the electronic device 200 may control the user device 102 to display visual objects for the plurality of image frames of the first video in the fourth region 1240, as described with reference to FIG. 12. Additionally, the electronic device 200 may control the user device 102 to display the visual object for the selected image frame, based on user input, in the fifth region 1250.

According to various embodiments, if user input for the icon 1911 related to key-point selection input is obtained for the first video uploaded through the user device 102, the electronic device 200 may control the user device to additionally display icons for executing functions related to drawing key-points. Furthermore, according to various embodiments, if user input for the icon 1911 related to key-point selection input is obtained, the electronic device 200 may acquire additional input for selecting a specific object among the multiple objects within the image frame.

For example, the electronic device 200 may obtain an input for selecting a first object 1912 among the plurality of objects in the first video through the user device 102. According to various embodiments, the input for selecting the first object 1912 may be obtained through various methods. For example, the various methods may include a mouse click, a touch input, a sound input, a character input, a keyboard input, and the like.

According to various embodiments, as user input for selecting the first object 1912 is obtained, the electronic device 200 may identify the contour of the first object 1912 based on the user input. Consequently, the user device 102 may display, in the fourth region 1240, a visual object 1913 (Base Segment) indicating the identification of at least one object in the plurality of image frames using the object recognition model, and a visual object 1914 (Point Human1) indicating the recognition of the first object 1912 based on the user input.

According to various embodiments, if user input for the icon 1911 related to key-point selection input is obtained, the electronic device 200 may acquire additional input for selecting a specific object among the multiple objects within the image frame.

For example, when a text input is selected as an input for selecting an object in the first video, the electronic device 200 may display a text input icon 1921 for acquiring a text input through the user device 102. At this time, the user may input the text 1922 for selecting an object as the text input icon 1921 is displayed.

According to various embodiments, if text input 1922 for selecting an object is obtained through the user device 102, the electronic device 200 may identify the user intent based on the text 1922 and select at least one object in the first video. For example, if the text input obtained through the user device 102 is “Add all people,” the electronic device 200 may interpret the text and identify all person objects included in the first video.

According to various embodiments, based on the user input (e.g., “Add all people”), the electronic device 200 may identify the contours 1931 of all person objects (first person object, second person object, third person object) included in the first video. Consequently, the user device 102 may display, in the fourth region 1240, a visual object 1913 (Base Segment) indicating the identification of at least one object in the plurality of image frames using the object recognition model, along with visual objects indicating the recognition of the first person object (Point Human1), the second person object (Point Human2) 1932, and the third person object (Point Human3) 1933 based on the user input.

According to various embodiments, the electronic device 200 may allow input for selecting at least one object, identifying the contours of at least one object, and editing at least one object in the first video not only through bounding box input and point input but also through various methods such as text input and sound input. The electronic device 200 may understand the user intent from the input obtained through the user device 102 and provide functions appropriate to the user intent.

As described above, the electronic device may include a communication device, a storage device configured to store an object recognition model trained to generate points and bounding boxes for at least one object included in a video, and at least one processor. The at least one processor may be configured to obtain, via the communication device, a first video including a plurality of first image frames from a user device connected to the electronic device, obtain a point set and a bounding box set for at least one object included in the first video using the object recognition model, identify a contour of the at least one object based on the point set and the bounding box set, obtain a mask for segmenting the at least one object based on the contour of the at least one object identified from the first video, obtain a second video by using the mask to remove regions other than the at least one object in the first video and transmit the second video to the user device via the communication device such that the user device outputs the second video.

According to various embodiments, the at least one processor may be configured to generate image frame groups by grouping the plurality of first image frames included in the first video in a pre-set reference unit, and to obtain the point set and the bounding box set by tracking the at least one object for each image frame group using the object recognition model.

According to various embodiments, the at least one processor may be configured to recognize a scene change of the first video using the object recognition model, and to generate the video frame groups by grouping the plurality of first video frames based on the scene change.

According to various embodiments, the object recognition model may extract skeleton data of the at least one object included in each of the plurality of first image frames to generate the point set and generate bounding boxes for the at least one object included in each of the plurality of first image frames to create the bounding box set.

According to various embodiments, the at least one processor may be configured to obtain a user input for an object to be identified through the user device, and to determine the at least one object to be identified through the object recognition model based on the user input.

According to various embodiments, the at least one processor may obtain multiple masks for segmenting the at least one object based on its contour and may obtain the mask based on the reliability of the multiple masks.

According to various embodiments, the at least one processor may obtain second image frames by using the mask to remove regions other than the at least one object and may obtain a second video using the second image frames and audio information from the first video.

According to various embodiments, the at least one object may be the foreground of the first video, and the second video may be a video in which the background, excluding the foreground, is removed from the first video.

According to various embodiments, the at least one processor may obtain user input for mask generation from the user device and may obtain the mask based on the user input for mask generation and the contour of the at least one object.

According to various embodiments, the user input for mask generation may include at least one of text input regarding the at least one object among the plurality of objects in the first video, point selection for the at least one object, bounding box selection, or masking region selection.

As described above, the method of operating the electronic device may include obtaining a first video including a plurality of first image frames from a user device connected to the electronic device, obtaining a first point set and a first bounding box set for at least one object included in the first video using an object recognition model trained to generate points and bounding boxes for objects in a video, identifying the at least one object based on the first point set and the first bounding box set, obtaining a mask for segmenting the identified at least one object in the first video, obtaining a second video by using the mask to remove regions other than the at least one object in the first video and transmitting the second video to the user device such that the user device outputs the second video.

According to various embodiments, the method of operating the electronic device may further include generating image frame groups by grouping the plurality of first image frames included in the first video into the image frame groups based on a predetermined reference unit and obtaining the point set and the bounding box set by tracking the at least one object in each of the image frame groups using the object recognition model.

According to various embodiments, the object recognition model may extract skeleton data of the at least one object included in each of the plurality of first image frames to generate the point set and may generate bounding boxes for the at least one object included in each of the plurality of first image frames to create the bounding box set.

According to various embodiments, the at least one object may be the foreground of the first video, and the second video may be a video in which the background, excluding the foreground, is removed from the first video.

According to various embodiments, in a non-volatile recording medium readable by a computer, recorded with a program of an operating method executable by a processor of an electronic device, the operating method may include obtaining a first video including a plurality of first image frames from a user device connected to the electronic device, obtaining a first point set and a first bounding box set for at least one object included in the first video using an object recognition model trained to generate a point and a bounding box for at least one object included in the video, identifying the at least one object based on the first point set and the first bounding box set, obtaining mask for segmenting the at least one object of the first video identified from the first image, obtaining a second video from which a region excluding the at least one object of the first video is removed using the mask, and transmitting the second video to the user device to output the second video.

As described above, the electronic device may include at least one camera, a display device, a communication device, a storage device configured to store an object recognition model trained to generate points and bounding boxes for at least one object included in a video, and at least one processor. The at least one processor may be configured to obtain a first video including a plurality of first image frames through the at least one camera, obtain a point set and a bounding box set for at least one object included in the first video using the object recognition model, identify a contour of the at least one object based on the point set and the bounding box set, obtain a mask for segmenting the at least one object based on the contour of the at least one object identified from the first video, obtain a second video by using the mask to remove regions other than the at least one object in the first video and control the display device to output the second video.

In the present disclosure, each of the phrases such as “a or b,” “a and b at least one of a and b,” “a and b at least one of a and b,” “a, b, or c,” “a, b, and c at least one of a and b,” and “a, b, or c at least one of a and b,” may include any one of the items listed together in the corresponding phrase among the phrase, or any combination of them.

Terms such as “first,” “second,” “primary,” or “secondary” may be used merely to distinguish one component from another and are not intended to limit the components in any other aspect (e.g., importance or sequence).

The term “module,” as used in various embodiments of this disclosure, may include a unit implemented in hardware, software, or firmware. For instance, it may be used interchangeably with terms such as logic, logic block, component, or circuit. A module may be an integral component or the smallest unit of the component or part thereof that performs one or more functions.

Various embodiments of this disclosure may be implemented as software (e.g., a program) that includes one or more instructions stored in a storage device 220 (e.g., internal memory or external memory) readable by a device (e.g., the electronic device 200). The storage device 220 may be represented as a storage medium.

In one embodiment, the methods according to the various embodiments disclosed in this document may be provided as a computer program product. The computer program product may be traded as a commodity between sellers and buyers. It may be distributed in the form of a storage medium readable by a device (e.g., compact disc read-only memory (CD-ROM)) or distributed online, such as through an application store or directly between two user devices, via download or upload.

According to various embodiments, each component (e.g., module or program) of the above-described components may include a single entity or a plurality of entities, and some of the plurality of entities may be separately arranged in other components. According to various embodiments, one or more components or operations among the corresponding components described above may be omitted, or one or more other components or operations may be added. Additionally or alternatively, a plurality of components (e.g., modules or programs) may be integrated into one component. In this case, the integrated component may perform one or more functions of each component of the plurality of components, the same as or similar to that performed by the corresponding component among the plurality of components before the integration.

According to various embodiments, operations performed by modules, programs, or other components may be executed sequentially, in parallel, repeatedly, or heuristically, one or more of the operations may be executed in a different order, omitted, or one or more other operations may be added.

What is claimed is:

1. An electronic device comprising:
a communication device;
a storage device configured to store an object recognition model trained to generate points and bounding boxes for at least one object included in a video; and
at least one processor,
wherein the at least one processor is configured to:
obtain, via the communication device, a first video including a plurality of first image frames from a user device connected to the electronic device;
obtain a point set and a bounding box set for at least one object included in the first video using the object recognition model;
identify a contour of the at least one object based on the point set and the bounding box set;
obtain a mask for segmenting the at least one object based on the contour of the at least one object identified from the first video;
obtain a second video by using the mask to remove regions other than the at least one object in the first video; and
transmit the second video to the user device via the communication device such that the user device outputs the second video.

2. The electronic device of claim 1,
wherein the at least one processor is configured to generate image frame groups by grouping the plurality of first image frames included in the first video into the image frame groups based on a predetermined reference unit and obtain the point set and the bounding box set by tracking the at least one object in each of the image frame groups using the object recognition model.

3. The electronic device of claim 2,
wherein the at least one processor is configured to recognize scene change in the first video using the object recognition model and generate the image frame groups by grouping the plurality of first image frames based on the scene change.

4. The electronic device of claim 1,
wherein the object recognition model is configured to generate the point set by extracting skeleton data of the at least one object included in each of the plurality of first image frames and generate the bounding box set for the at least one object included in each of the plurality of first image frames.

5. The electronic device of claim 4,
wherein the at least one processor is configured to:
obtain an user input regarding a target object through the user device; and
determine the at least one object to be recognized by the object recognition model based on the user input.

6. The electronic device of claim 1,
wherein the at least one processor is configured to:
obtain a plurality of masks for segmenting the at least one object based on the contour of the at least one object; and
obtain the mask based on the reliability of the plurality of masks.

7. The electronic device of claim 1,
wherein the at least one processor is configured to:
obtain a plurality of second image frames by using the mask to remove regions other than the at least one object; and
obtain the second video using the plurality of second image frames and audio information of the first video.

8. The electronic device of claim 1,
wherein the at least one object is a foreground of the first video, and
the second video is a video in which the background, excluding the foreground, has been removed from the first video.

9. The electronic device of claim 1,
wherein the at least one processor is configured to:
obtain an user input for mask generation from the user device; and
obtain the mask based on the user input for mask generation and the contour of the at least one object.

10. The electronic device of claim 9,
wherein the user input for mask generation includes at least one of text input regarding the at least one object among the plurality of objects in the first video, point selection for the at least one object, bounding box selection, or masking region selection.

11. A method of operating an electronic device, the method comprising:
obtaining a first video including a plurality of first image frames from a user device connected to the electronic device;
obtaining a first point set and a first bounding box set for at least one object included in the first video using an object recognition model trained to generate points and bounding boxes for objects in a video;
identifying the at least one object based on the first point set and the first bounding box set;
obtaining a mask for segmenting the identified at least one object in the first video;
obtaining a second video by using the mask to remove regions other than the at least one object in the first video; and
transmitting the second video to the user device such that the user device outputs the second video.

12. The method of claim 11, further comprising:
generating image frame groups by grouping the plurality of first image frames included in the first video into the image frame groups based on a predetermined reference unit; and
obtaining the point set and the bounding box set by tracking the at least one object in each of the image frame groups using the object recognition model.

13. The method of claim 11,
wherein the object recognition model extracts skeleton data of the at least one object included in each of the plurality of first image frames to generate the point set and generates the bounding box set for the at least one object included in each of the plurality of first image frames.

14. The method of claim 11,
wherein the at least one object is a foreground of the first video, and
the second video is a video in which the background, excluding the foreground, has been removed from the first video.

15. A non-transitory computer-readable recording medium storing a program executable by a processor of an electronic device, the program comprising instructions to:
obtain a first video including a plurality of first image frames from a user device connected to the electronic device;
obtain a first point set and a first bounding box set for at least one object included in the first video using an object recognition model trained to generate points and bounding boxes for objects in a video;
identify the at least one object based on the first point set and the first bounding box set;
obtain a mask for segmenting the identified at least one object in the first video;
obtain a second video by using the mask to remove regions other than the at least one object in the first video; and
transmit the second video to the user device such that the user device outputs the second video.
